(19) United States
(12) Patent Application Publication
(10) Pub. No.: US 2016/0087295 A1
(43) Pub. Date: Mar. 24, 2016

(54) Catalyst and Process for the Production of Hydrogen from Ammonia Boranes

(71) Applicant: NOVAUCD, Dublin (IE)

(72) Inventors: Andrew Phillips, Dublin (IE); Christian Grave, Dublin (IE); Gurmeet Singh Bindra, Dublin (IE); Crystal O'Connor, Dublin (IE); Vsevolod Khlebnikov, Dublin (IE)

(21) Appl. No.: 14/786,375

(22) PCT Filed: Apr. 23, 2014
(86) PCT No.: PCT/IB2014/060946

§ 371 Date: Oct. 22, 2015

(30) Foreign Application Priority Data
Apr. 23, 2013 (GB) 1307334.1

(51) Int. Cl. H01M 8/06; B01J 31/22; H01M 8/10; C07F 15/00; B01J 19/24; C01B 3/06; B01J 31/18

(52) U.S. Cl. CPC H01M 8/0612; C01B 3/06; B01J 31/2295; B01J 31/226; B01J 31/184; C07F 15/0046; C07F 15/0053; C07F 15/002; C07F 15/0026; B01J 19/24; H01M 8/10; B01J 2531/821; B01J 2531/847; B01J 2231/76; B01J 2219/24; B01J 2219/00164; H01M 2008/1095

(57) ABSTRACT

The present invention relates to a process for the production of hydrogen comprising contacting at least one complex of formula (I), (I) wherein: X⁻ is an anion; M is a metal selected from Ru, Os, Fe, Co and Ni; D is optionally present and is one or more monodentate or multidentate donor ligands; Y¹ is selected from CR¹³, B and N; Z¹ and Z² are each independently selected from ═N, ═P, NR¹⁴, PR¹⁵, O, S and Se; or Z² is a direct bond between carbocyclic ring B and substituent R⁴; each of A and B is independently a saturated, unsaturated or partially unsaturated carbocyclic hydrocarbon ring; R³ and R⁴ are each independently selected from H, C₁₋₆-alkyl, aryl and C₁₋₆-haloalkyl, and a linker group optionally attached to a solid support; or R³ and R⁴ together form the following moiety: (AB) Y² is a direct single bond or double bond, or is CR¹⁸; R¹, R², R⁵⁻¹³ and R¹⁶⁻¹⁸ are each independently selected from H, C₁₋₆-alkyl, C₂₋₆-alkenyl, C₂₋₆-alkynyl, aryl, C₁₋₆-haloalkyl, NR¹⁹R²⁰ and a linker group optionally attached to a solid support; or two or more of said R¹⁻¹³ and R¹⁶⁻¹⁸ groups are linked, together with the carbons to which they are attached, to form a saturated or unsaturated hydrocarbon group; R¹⁴, R¹⁵, R¹⁹ and R²⁰ are each independently selected from H, C₁₋₆-alkyl, C₂₋₆-alkenyl, C₂₋₆-alkynyl, aryl, C₁₋₆-haloalkyl, and a linker group optionally attached to a solid support; with at least one substrate of formula (II), R²¹R²²NH—BHR²³R²⁴, wherein R²¹ to R²⁴ are each independently selected from H, C₁₋₆-alkyl, fluoro-substituted C₁₋₆-alkyl, C₆₋₁₄-aryl and C₆₋₁₄-aralkyl, or any two of R²¹, R²², R²³ and R²⁴ are linked to form a C₃₋₁₀-alkylene group or C₃₋₁₀-alkenylene group, which together with the nitrogen and/or boron atoms to which they are attached, forms a cyclic group; or a substrate comprising two, three or four substrates of formula (II) linked via one or more bridging groups so as to form a dimeric, trimeric or tetrameric species, and wherein the bridging group is selected from straight or branched C₁₋₆-alkylene optionally substituted by one or more fluoro groups, boron, C₆₋₁₄-aryl and C₆₋₁₄-aralkyl; or a substrate comprising two, three or four substrates of formula (II) which are joined so as to form a fused cyclic dimeric, trimeric or tetrameric species. Further aspects of the invention relate to a hydrogen generation system comprising a complex of formula (I), a substrate of formula (II) and a solvent, and to the use of complexes of formula (I) in fuel cells. Another aspect of the invention relates to novel complexes of formula (I).

The present invention relates to a process for the production of dihydrogen. More specifically, the invention relates to a process for catalysing the release of dihydrogen from ammonia borane, and derivatives thereof, using a transition metal catalyst. The process of the invention has important applications in the field of hydrogen fuel cells.

### BACKGROUND TO THE INVENTION

The combustion of hydrogen and oxygen is regarded as the cleanest possible source of energy, with water as the only product. Scientific agencies across the globe have clearly stated the need for the safe storage of hydrogen, which at high pressure is extremely explosive. In order to secure practical useable amounts of hydrogen, reinforced heavy steel walled pressurized gas tanks are generally used. In transportation applications, this leads to a significant waste of energy in carrying the extra weight required for the hydrogen cylinder. Moreover, the refilling of pressurized hydrogen represents a significant hazard.

One way of solving the problem of safe transportation is to use chemical hydrides as an alternative source of releasable hydrogen. Chemical hydrides can be packaged as non-pyrophoric, non-hazardous, solid, slurried or liquid fuels. Hydrogen may then be generated on demand from the chemical hydride under controlled conditions. Ideally, hydrogen storage materials have a high hydrogen content and a low molecular weight. One such example is ammonia borane, H₃N—BH₃, which has a very high hydrogen content by weight (19.2%) and is attracting attention as a means of achieving efficient chemical hydrogen storage.

Although the cost of ammonia borane is still high compared to other hydrides, substantial research efforts are directed to finding new methods of synthesis. Numerous methods for obtaining large amounts of hydrogen from ammonia borane are documented in the art (Reviews: Chem. Soc. Rev. 2009, 38, 279-293; Chem. Rev. 2010, 110, 4079-4124). The formation of very stable B—O bonds is a major drawback of solvolysis methods, which makes the regeneration of spent fuel difficult. This problem is overcome with the use of catalysts in non-aqueous solutions under mild conditions.

More recently, Weller and Lloyd-Jones et al (J. Am. Chem. Soc., 2012, 134, 3598-3610) described the use of a rhodium-based catalyst, [Rh(PCy₃)₂]⁺, for the dehydrocoupling of amino boranes. Williams et al (Chem Commun Camb, 2010 Jul. 14; 46(26):4815-7; Organometallics 2012, 30, 6705-6714; and US20120201744; University of Southern California) described the dehydrogenation of amino borane by Shvo's catalyst, a cyclopentadienone-ligated ruthenium complex. A second generation catalyst based on Shvo's catalyst is also disclosed. Schneider et al (Angew. Chem. Int. Ed. 2009, 48, 905-907) described ruthenium complexes with tridentate PNP (diphosphinoamine) ligands as bifunctional catalysts for the dehydrogenation of ammonia borane.

US 2009274613 (Hamilton et al) discloses the production of hydrogen from ammonia borane using a catalyst complex of the formula Lₙ-M-X, where M is a base metal such as Fe, Mn, Co, Ni and Cu, X is an anionic nitrogen- or phosphorus-based ligand or hydride, and L is a neutral ancillary ligand that is a neutral monodentate or polydentate ligand.

U.S. Pat. No. 7,544,837 (Blacquiere et al) describes a method of dehydrogenating an amine-borane of formula R¹H₂N—BH₂R² using a base metal catalyst, to generate hydrogen and at least one of a [R¹HN—BHR²], oligomer and a [R¹N—BR²]ₙ oligomer. Base metal catalysts are defined as transition metals other than Pt, Pd, Rh, Os and Ru. The method has applications in the field of fuel cells.

The use of ligand stabilized homogenous catalysts containing Ru, Co, Ir, Ni and Pd to catalyse the release of hydrogen from ammonia borane is also described in WO 2008141439 (Kanata Chemical Technologies Inc.). Suitable ligands include phosphines, aminophosphines, heterocyclic ligands, diaminophosphines, diamines, thiophines and thioamines.

US 20080159949 (Mohajeri et al) discloses a method of generating hydrogen from an ammonia borane complex using catalysts including cobalt complexes, noble metal complexes and metallocenes. Examples of suitable noble metal catalysts include NaRhCl₆, chlorotris(triphenylphosphine) Rh (I), (NH₄)₂RuCl₆K₂PtCl₆, (NH₄)₂PtCl₆Na₂PtCl₆, H₂PtCl₆, Fe(C₅H₅)₂ and di-p-chlorobis(p-cymene)chlororuthenium. The method is suitable for use in polymer electrolyte membrane fuel cells (also known as proton exchange or PEMFCs).

JP2011-116681 (Hiroyuki et al) discloses an Fe based metal-boron complex as catalyst to dehydrogenate ammonia borane.

Over recent years, significant effort has been put into developing new hydrogen storage methods. However, all of the methods reported to date feature a number of potential drawbacks which potentially limit their commercial applications. The first is the high cost associated with the iridium or rhodium metal catalysts reported to date. The second problem is sensitivity to atmospheric oxygen, which at low levels significantly deactivates iridium and rhodium-based systems. Thus, it would be advantageous to develop a catalyst which shows a higher degree of tolerance to atmospheric oxygen.

Moreover, only few catalysts achieve high hydrogen release activity under mild conditions.

More importantly, the majority of homogenous metal-based dehydrogenation catalytic complexes developed to date tend to operate and produce high pressures even at the storage stage. This leads to potential safety hazards which necessitate the use of reaction containers that are able to withstand significantly higher pressures. Synthesis and further adaptation of the ligand system is difficult and requires multiple steps with costly separations.

Finally, reversibility through regeneration back to original ammonia borane is not feasible with many of the single site metal catalysts reported to date. Furthermore, these single site catalysts do not possess the ability to switch off at low hydrogen pressure, thereby creating potentially dangerous pressures, especially in situations where the cell is exposed to elevated temperatures.

Recent studies by the present applicant investigated the application of β-diketiminato arene-substituted Ru(II) complexes as bifunctional, i.e. dual-site, catalysts in the dehydrocoupling of amino boranes (Phillips et al, ACS Catal. 2012, 2, 2505-2511; and WO 2011151792; Nova UCD). Various structural analogues are also described. The catalysts rapidly perform homolytic cleavage of hydrogen under mild conditions through bifunctional metal-ligand interaction. The p-diketiminato-ruthenium type complexes described by the authors offer several advantages, the most important being liberating H₂ from ammonia borane in a potentially reversible way.

The present invention seeks to provide alternative methods of generating hydrogen. Specifically, the invention seeks to provide a means for storing hydrogen that allows for the controlled and safe release of dihydrogen at a constant rate. In a preferred aspect, the invention seeks to provide catalysts suitable for the catalytic dihydrogen decoupling of ammonia boranes that exhibit improved turnover and/or enhanced reaction kinetics compared to catalysts previously described in the art. Moreover, the present catalyst offer improved long term stability to oxygen and moisture.

### STATEMENT OF INVENTION

The present invention broadly relates to a process for the catalytic dihydrogen decoupling of ammonia borane and derivatives thereof.

More specifically, a first aspect of the invention relates to a process for the production of dihydrogen comprising contacting at least one complex of formula (I),

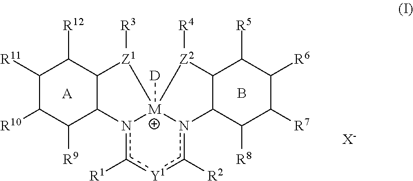

wherein:
X⁻ is an anion;
M is a metal selected from Ru, Os, Fe, Co and Ni;
D is optionally present and is one or more monodentate or multidentate donor ligands;
Y¹ is selected from CR¹³, B and N;
Z¹ and Z² are each independently selected from ═N, ═P, NR¹⁴, PR¹⁵, O, S and Se; or
Z² is a direct bond between carbocyclic ring B and substituent R⁴;
each of A and B is independently a saturated, unsaturated or partially unsaturated carbocyclic hydrocarbon ring;
R³ and R⁴ are each independently selected from H, C₁₋₆-alkyl, aryl and C₁₋₆-haloalkyl, and a linker group optionally attached to a solid support; or
R³ and R⁴ together form the following moiety:

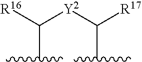

Y² is a direct single bond or double bond, or is CR¹⁸;
R¹, R², R⁵⁻¹³ and R¹⁶⁻¹⁸ are each independently selected from H, C₁₋₆-alkyl, C₂₋₆-alkenyl, C₂₋₆-alkynyl, aryl, C₁₋₆-haloalkyl, NR¹⁹R²⁰ and a linker group optionally attached to a solid support;
or two or more of said R¹⁻¹³ and R¹⁶⁻¹⁸ groups are linked, together with the carbons to which they are attached, to form a saturated or unsaturated hydrocarbon group;
R¹⁴, R¹⁵, R¹⁹ and R²⁰ are each independently selected from H, C₁₋₆-alkyl, C₂₋₆-alkenyl, C₂₋₆-alkynyl, aryl, C₁₋₆-haloalkyl, and a linker group optionally attached to a solid support;
with at least one substrate of formula (II)

R²¹R²²—NH—BH—R²³R²⁴ (II)

wherein R²¹ to R²⁴ are each independently selected from H, C₁₋₆-alkyl, fluoro-substituted C₁₋₆-alkyl, C₆₋₁₄-aryl and C₆₋₁₄-aralkyl, or any two of R²¹, R²², R²³ and R²⁴ are linked to form a C₃₋₁₀-alkylene group or C₃₋₁₀-alkenylene group, which together with the nitrogen and/or boron atoms to which they are attached, forms a cyclic group;
or a substrate comprising two, three or four substrates of formula (II) linked via one or more bridging groups so as to form a dimeric, trimeric or tetrameric species, and wherein the bridging group is selected from straight or branched C₁₋₆-alkylene optionally substituted by one or more fluoro groups; boron; C₆₋₁₄-aryl; and C₆₋₁₄-aralkyl;
or a substrate comprising two, three or four substrates of formula (II) which are joined so as to form a fused cyclic dimeric, trimeric or tetrameric species.

Advantageously, the presently described process involves the use of a homogenous catalyst that activates gaseous dihydrogen. Ab initio calculations and experimental evidence have shown that a bifunctional mechanism is operative for the dehydrocoupling of ammonia borane. Thus, the unique dual site design of the p-diketiminato-metal complex offers the possibility for reversible H₂ coupling, thereby regenerating the original ammonia borane and eliminating the need for external removal and reloading of the energy storage medium.

The presently claimed catalyst system displays enhanced dehydrogenation kinetics compared to the previously described first generation systems described in WO 2011151792. The present catalysts can be synthesized in high yield from commercially available precursors and in the solid state under N₂ stored indefinitely. The catalyst-to-substrate ratio directly controls the rate of H₂ released. The catalysts are capable of extracting up to two equivalents of H₂ from the ammonia borane substrate.

A second aspect of the invention relates to a hydrogen generation system comprising:

(a) at least one complex of formula (I)

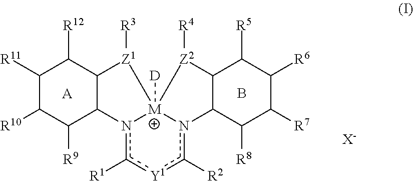

wherein:
X⁻ is an anion;
M is a metal selected from Ru, Os, Fe, Co and Ni;
D is optionally present and is one or more monodentate or multidentate donor ligands;
Y¹ is selected from CR¹³, B and N;
Z¹ and Z² are each independently selected from ═N, ═P, NR¹⁴, PR¹⁵, O, S and Se; or
Z² is a direct bond between carbocyclic ring B and substituent R⁴;
each of A and B is independently a saturated, unsaturated or partially unsaturated carbocyclic hydrocarbon ring;
R³ and R⁴ are each independently selected from H, C₁₋₆-alkyl, aryl and C₁₋₆-haloalkyl, and a linker group optionally attached to a solid support; or
R³ and R⁴ together form the following moiety:

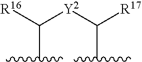

Y² is a direct single bond or double bond, or is CR¹⁸;
R¹, R², R⁵⁻¹³ and R¹⁶⁻¹⁸ are each independently selected from H, C₁₋₆-alkyl, C₂₋₆-alkenyl, C₂₋₆-alkynyl, aryl, C₁₋₆-haloalkyl, NR¹⁹R²⁹ and a linker group optionally attached to a solid support;
or two or more of said R¹⁻¹³ and R¹⁶⁻¹⁸ groups are linked, together with the carbons to which they are attached, to form a saturated or unsaturated hydrocarbon group;
R¹⁴, R¹⁵, R¹⁹ and R²⁰ are each independently selected from H, C₁₋₆-alkyl, C₂₋₆-alkenyl, C₂₋₆-alkynyl, aryl, C₁₋₆-haloalkyl, and a linker group optionally attached to a solid support;
(b) at least one substrate of formula (II)

R²¹R²²NH—BHR²³R²⁴ (II)

wherein R²¹ to R²⁴ are each independently selected from H, C₁₋₆-alkyl, fluoro-substituted C₁₋₆-alkyl, C₆₋₁₄-aryl and C₆₋₁₄-aralkyl, or any two of R²¹, R²², R²³ and R²⁴ are linked to form a C₃₋₁₀-alkylene group or C₃₋₁₀-alkenylene group, which together with the nitrogen and/or boron atoms to which they are attached, forms a cyclic group;
or a substrate comprising two, three or four substrates of formula (II) linked via one or more bridging groups so as to form a dimeric, trimeric or tetrameric species, and wherein the bridging group is selected from straight or branched C₁₋₆-alkylene optionally substituted by one or more fluoro groups; boron; C₆₋₁₄-aryl; and C₆₋₁₄-aralkyl;
or a substrate comprising two, three or four substrates of formula (II) which are joined so as to form a fused cyclic dimeric, trimeric or tetrameric species; and
(c) optionally, a solvent.

A third aspect of the invention relates to the use of at least one complex of formula (I) as defined above in a fuel cell.

A fourth aspect of the invention relates to a fuel cell comprising at least one complex of formula (I) as defined above.

A fifth aspect of the invention relates to a method of thermolytically dehydrogenating a substrate of formula (II) as described above, said method comprising contacting at least one substrate of formula (II) with a complex of formula (I) in the presence of a solvent.

A sixth aspect of the invention relates to the use of at least one complex of formula (I) as defined above in a method of thermolytically dehydrogenating a substrate of formula (II) as described above.

A seventh aspect of the invention relates to the use of at least one complex of formula (I) as defined above in a method of producing hydrogen.

An eighth aspect of the invention relates to complexes of formula (I).

A ninth aspect of the invention relates to a method of using a hydrogen generation system as defined above which comprises modulating the hydrogen pressure in said system so as to modulate activity of the at least one complex of formula (I).

### DETAILED DESCRIPTION

As used herein, the term “C₁₋ₙalkyl” means straight or branched chain, saturated alkyl groups containing from one to n carbon atoms and includes (depending on the identity of n) methyl, ethyl, propyl, isopropyl, n-butyl, s-butyl, isobutyl, t-butyl, 2,2-dimethylbutyl, n-pentyl, 2-methylpentyl, 3-methylpentyl, 4-methylpentyl, n-hexyl and the like, where the variable n is an integer representing the largest number of carbon atoms in the alkyl group. In one preferred embodiment, the C₁₋ₙalkyl group is a C₁₋₂₀-alkyl group, more preferably a C₁₋₆-alkyl group, even more preferably, a C₁₋₃-alkyl group.

As used herein, the term “C₁₋ₙ-haloalkyl” refers to a C₁₋ₙ-alkyl group as defined above in which one or more hydrogens are replaced with a halogen atom selected from Br, F, Cl and I. Preferably, the C₁₋ₙ-haloalkyl group is a C₁₋₂₀-haloalkyl group, more preferably a C₁₋₁₀-haloalkyl group, even more preferably, a C₁₋₆-haloalkyl group. In one particularly preferred embodiment, the C₁₋ₙ-haloalkyl group is a C₁₋ₙ-fluoroalkyl group, more preferably, a C₁₋₂₀-fluoroalkyl group, even more preferably a C₁₋₁₀-fluoroalkyl group, even more preferably still, a C₁₋₆-fluoroalkyl group. CF₃ is a particularly preferred C₁₋₆-fluoroalkyl group.

As used herein, the term “C₆₋ₙaryl” means a monocyclic, bicyclic or tricyclic carbocyclic ring system containing from 6 to n carbon atoms and at least one aromatic ring and includes, depending on the identity of n, phenyl, naphthyl, anthracenyl, 1,2-dihydronaphthyl, 1,2,3,4-tetrahydronaphthyl, fluorenyl, indanyl, indenyl and the like, where the variable n is an integer representing the largest number of carbon atoms in the aryl group. In one preferred embodiment, the C₆₋ₙaryl group is a C₆₋₁₄-aryl group, more preferably, a C₆₋₁₀-aryl group, even more preferably, a phenyl group.

As used herein, the term “aralkyl” means a conjunction of C₁₋ₙalkyl or C₁₋ₙ-haloalkyl and C₆₋ₙaryl as defined above. Preferred aralkyl groups include benzyl.

As used herein, the term “carbocyclic ring” means a carbon-containing ring system, that includes monocycles, fused bicyclic and polycyclic rings, bridged rings and metallocenes. Where specified, one or more carbons in the rings may be substituted or replaced with heteroatoms. Preferably, the carbocyclic group is cyclohexyl.

In one highly preferred embodiment, each of A and B is independently an unsaturated carbocyclic ring, more preferably a phenyl ring. Carbocyclic ring A is substituted by groups R⁹-R¹² as defined above, whereas carbocyclic ring B is substituted by groups R⁵-R⁸ as defined above.

As used herein, the term “fluoro-substituted” means that one or more, including all, of the hydrogens in the group have been replaced with fluorine.

The suffix “ene” added on to any of the above groups means that the group is divalent, i.e. inserted between two other groups.

A first aspect of the invention relates to a process for the production of hydrogen comprising contacting at least one complex of formula (I), with at least one substrate of formula (II) as defined above. Preferably, the process is carried out in the presence of a suitable solvent.

The invention consists of a catalyzed chemical process for the controlled and safe release of hydrogen at constant rate from the substrate ammonia borane or related organic N,B-substituted derivatives. The overall purpose of the process is to provide a constant flow rate of high purity hydrogen for use in fuel cells or combustion engines, which in combination with atmospheric oxygen emit only water. No external heating, light or electricity is required to initiate the catalytic dehydrogenation process. Hydrogen has been shown to carry an extremely high energy to mass ratio of 120 MJ kg⁻¹ as compared to conventional gasoline products (44 MJ kg⁻¹).

The present applicant has synthesized a series of different derivatives of the catalytic complex. A number of these have been tested in dehydrogenation reactions under different conditions (variation of substrate, solvent, concentration, temperature) and in direct comparison to catalysts of the first generation (see, for example, WO 2011151792). The release of over two equivalents of H₂ from ammonia borane was achieved.

The applicant's previous application (WO 2011151792) described the unique dual site design of the β-diketiminato-ruthenium complex, which offers the possibility for reversible H₂ coupling, thereby regenerating the original ammonia borane and eliminating the need for external removal and reloading the energy storage medium.

The presently claimed invention provides a significantly improved dual site catalyst system. The unique tetra-coordinating anionic diketiminato ligand leads to an immediate loss of the supporting ligand in solution, creating a large free reactive site and consequently enhanced reaction kinetics. Moreover the catalytic activity of the β-diketiminato-ruthenium complex can be modified through simple changes in the ligand design. Anchoring of the catalyst to solid support is also possible, thereby facilitating easy separation of the spent materials.

### Substrate of Formula (II)

The process of the invention uses a substrate of formula (II), R²¹R²²NH—BHR²³R²⁴, as described above.

Preferably, R²¹, R²², R²³ and R²⁴ are each independently selected from H, C₁₋₁₀-alkyl, fluoro-substituted-C₁₋₁₀-alkyl, C₆₋₁₀-aryl and C₆₋₁₀-aralkyl, or any two of R²¹, R²², R²³ and R²⁴ are linked to form a C₂₋₆-alkylene group, which together with the nitrogen and/or boron atoms to which they are attached, forms a cyclic group.

More preferably, R²¹, R²², R²³ and R²⁴ are each independently selected from H, C₁₋₆-alkyl, fluoro-substituted-C₁₋₆-alkyl, C₆-aryl and C₆₋₁₀-aralkyl, or any two of R²¹, R²², R²³ and R²⁴ are linked to form a C₂₋₆-alkylene group, which together with the nitrogen and/or boron atoms to which they are attached, forms a cyclic group.

In one preferred embodiment, R²³ and R²⁴ are both H.

In one preferred embodiment, R²³ and R²⁴ are both H, and R²¹ and R²² are each independently selected from H, C₁₋₁₀-alkyl, fluoro-substituted-C₁₋₁₀-alkyl, C₆₋₁₀-aryl and C₅₋₁₀-aralkyl, or R²¹ and R²² are linked to form a C₂₋₆-alkylene group, which together with the nitrogen atom to which they are attached, forms a cyclic group.

More preferably, R²³ and R²⁴ are both H and R²¹ and R²² are each independently selected from H, C₁₋₁₀-alkyl, fluoro-substituted-C₁₋₁₀-alkyl and C₆₋₁₀-aryl.

In one preferred embodiment of the invention, R²¹, R²², R²³ and R²⁴ are each independently selected from H and C₁₋₂₀-alkyl.

In one highly preferred embodiment, R²³ and R²⁴ are both H, one of R²¹ and R²² is H and the other is selected from H, C₁₋₁₀-alkyl, C₁₋₁₀-fluoroalkyl, C₆₋₁₀-aryl and C₆₋₁₀-aralkyl.

More preferably, one of R²¹ and R²² is H and the other is selected from H, methyl, ethyl, isopropyl, n-propyl, isobutyl, n-butyl, tert-butyl, CF₃, fluorinated alkyl, sec-butyl, phenyl and benzyl.

In another highly preferred embodiment, R²³ and R²⁴ are both H, and R²¹ and R²² are each independently selected from H, methyl, ethyl, isopropyl, n-propyl, isobutyl, n-butyl, tert-butyl, sec-butyl, phenyl and benzyl, CF₃, or R²¹ and R²² are linked to form a C₂₋₆-alkylene group, which together with the nitrogen atom to which they are attached, form a cyclic group. Preferably, where R²¹ and R²² are linked to form a C₂₋₆-alkylene group, the C₂₋₆-alkylene group is a C₄-alkylene group.

In one preferred embodiment, two of R²¹, R²², R²³ and R²⁴ are linked to form a C₂₋₁₀-alkylene group, which together with the nitrogen and/or boron atoms to which they are attached, forms a cyclic group.

By way of example, in one particularly preferred embodiment, the substrate of formula II is selected from the following:

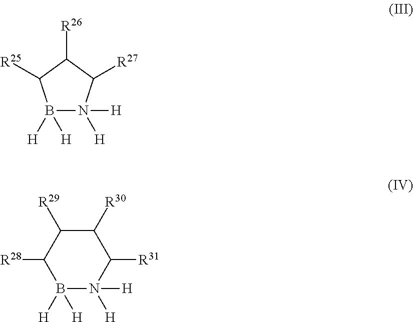

wherein each of R²⁵ to R³¹ is independently selected from alkyl and H. Compounds of formulas (III) and (IV) are described in Wei Luo, Lev N. Zakharov, and Shih-Yuan Liu, J. Am. Chem. Soc. 2011, 133, 13006-13009, and Wei Luo, Patrick G. Campbell, Lev N. Zakharov, and Shih-Yuan Liu, J. Am. Chem. Soc. 2011, 133, 19326-19329.

In another preferred embodiment, the substrate of formula II is of formula:

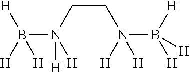

Compounds of this type are described in Neiner, D.; Karkamkar, A; Bowden, M.; Choi, J. Y.; Luedtke, A.; Holladay, J.; Fisher, A.; Szymczakc, N.; Autrey, T.: Energy Environ. Sci., 2011, 4, 4187.

In one preferred embodiment, the substrate of formula (II) is selected from ammonia borane, methylamine borane, dimethylamine borane, di-isopropylamine borane, isopropylamine borane, tert-butylamine borane, isobutylamine borane, phenylamine borane and pyrrolidine borane.

In one highly preferred embodiment, the substrate of formula (II) is dimethylamine borane.

In another highly preferred embodiment, the substrate of formula (II) is ammonia borane, H₃B—NH₃, i.e. R²¹, R²², R²³ and R²⁴ are all H. Ammonia borane is a non-combustible, industrially inexpensive, low molecular weight solid substrate that carries multiple molecular equivalents of hydrogen. Ammonia borane has a high hydrogen carrying capacity of 19.6% per weight and is not flammable. This is consistent with the objectives set forth by the US Department of Energy of 5.5 wt % in vehicles by 2015. Using a small amount (typically 0.5 to 1% mol) of a molecular catalyst (consisting of a metal and supporting organic ligands), decouples multiple equivalents of gaseous hydrogen from ammonia borane at a sustained rate at room temperature, or at elevated temperatures between 42 and 74° C.

### Complex of Formula (I)

The process of the invention utilises a complex of formula (I), as defined above, as a catalyst. The catalyst is a bifunctional dual site complex consisting of a transition metal and a ligand that is robust and stable over long periods of storage and reaction time.

In contrast to the first generation catalysts described in our earlier application (WO 201151792), which are η⁶-arene κ²-β-diketiminato ruthenium complexes, the presently claimed catalysts are tethered κ³-substituted-β-diketiminato or κ⁴-substituted-β-diketiminato ruthenium complexes. Advantageously, the presently claimed catalyst structures afford faster dehydrogenation kinetics compared to the first generation catalysts. As the rate of H₂ released also depends on the catalyst to substrate ratio, the additional benefit of this second catalyst generation can be, depending on the application, twofold: (i) to achieve a higher H₂ release rate, and/or (ii) to lower the amount of catalyst used (and consequently the cost of the system).

Advantageously, the presently claimed catalysts show a high degree of tolerance. Every catalyst is restricted by its turnover frequency, which determines the reaction kinetics and, by the amount of catalyst needed to achieve a certain rate, also the cost of the system. Any increase in the turnover number therefore represents a valuable contribution to the art. Compared to the first generation of catalysts described in WO 2011151792, the second generation of catalysts presented here excels in an increased turnover frequency.

It is understood that generally at some point, the donor ligand D dissociates in solution to form the active catalytic species, although at some point re-association cannot be ruled out. Some of the compounds are isolated after synthesis as a mixture of the complex with the donor ligand D and the complex where D has been lost. These mixtures can be used without further separation in the dehydrogenation experiments.

Further, it has to be noted that the coordination between M and Z¹ and/or M and Z² is not always clearly defined. The solid bond drawn in the structures between M and Z¹ or M and Z² therefore cannot be understood as excluding non-coordination for both Z¹ and Z² (as shown in the equilibrium between coordination and non-coordination below) or for any of Z¹ and Z² independently. The skilled person will be familiar with this nomenclature and structural representation of coordination sites.

For example, in one preferred embodiment, where the donor ligand D is η⁶-arene, Z¹ and Z² do not coordinate to M. However, in another preferred embodiment, where donor ligand D is absent, Z¹ and Z² do coordinate to M.

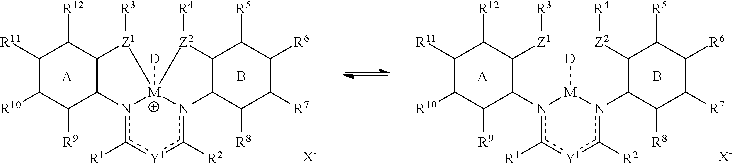

In one preferred embodiment of the invention, X⁻ is selected from OTf⁻, BF₄⁻, PF₆⁻, BPh₄⁻ or BArF⁻ (B((3,5-CF₃)₂C₆H₃)₄⁻) more preferably, ° Tr. As used herein, X⁻ does not imply a specific bond type to the metal M. X⁻ represents any bond type between the limits of a non-coordinated anion and a coordinated ligand with formally negative charge. In other words, X⁻ may or may not coordinate—weakly or strongly—with metal M.

In one preferred embodiment of the invention, M is selected from Ru, Ni and Co. More preferably, M is Ru.

In one preferred embodiment of the invention, R⁵-R¹² are each independently selected from H, methyl, CF₃ and isopropyl.

In one preferred embodiment of the invention, R₁ and R₂ are both independently C₁₋₆-alkyl, more preferably, methyl.

In one preferred embodiment of the invention, Y¹ is CR¹³, more preferably CH.

In formula (I), Z¹ and Z² are each independently selected from ═N (double bonded to R³ or R⁴ respectively, or double bonded to ring A or ring B respectively), ═P (double bonded to R³ or R⁴ respectively, or double bonded to ring A or ring B respectively), NR¹⁴, PR¹⁵, O, S and Se,

In one preferred embodiment of the invention, A and B are both phenyl groups, i.e. the compound is of formula (V):

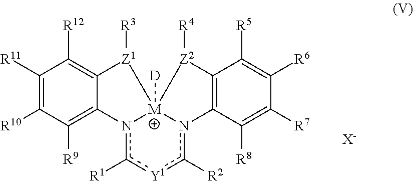

wherein R¹-R¹², D, M, Y¹, Z¹, Z² and X⁻ are as defined above.

In one preferred embodiment of the invention, Z¹R³ and Z²R⁴ are each independently S—C₁₋₆-alkyl, more preferably Z¹R³ and Z²R⁴ are each independently selected from SCH₃ and SCH₂CH₃.

In one preferred embodiment of the invention, Z¹R³ is S—C₁₋₆-alkyl, Z² is a direct bond and R⁴ to R⁸ are independently C₁₋₆-alkyl, more preferably Z¹R³ is selected from SCH₃ and SCH₂CH₃ and Z² is a direct bond, and R⁴ and R⁸ are methyl.

In one preferred embodiment of the invention, Z¹ and Z² are each independently selected from S and NR¹⁴.

In one preferred embodiment of the invention, Z¹ is selected from S and NR¹⁴, and Z² is a direct bond.

In one preferred embodiment of the invention, Z²R¹ and Z¹R² together form the following moiety:

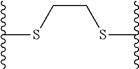 [SMILES: *SCCS*]

In one preferred embodiment, the complex is of formula (Va)

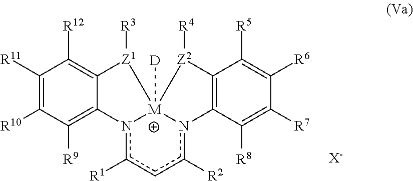

wherein:
X⁻ is an anion selected from Cl⁻, Br⁻, PF₆⁻, TfO⁻;
M is selected from Ru and Ni;
D is optional and is selected from (VI) and (VII),

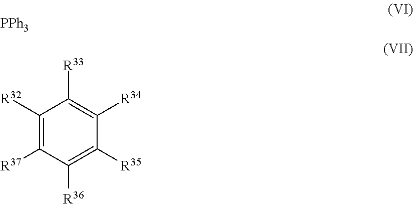

Z¹ and Z² are each independently selected from NR¹⁴, PR¹⁵, O and S; or Z² is a direct bond to R⁴;
R³ and R⁴ are each independently selected from H, C₁₋₆-alkyl, aryl and C₁₋₆-haloalkyl, and a linker group optionally attached to a solid support; or
R³ and R⁴ together form the following moiety:

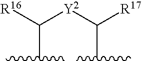

Y² is a direct single bond or double bond, or is CR¹⁸;
R¹, R², R⁵⁻¹³ and R¹⁶⁻¹⁸ are each independently selected from H, C₁₋₆-alkyl, C₂₋₆-alkenyl, C₂₋₆-alkynyl, aryl, C₁₋₆-haloalkyl, NR¹⁹R²⁰ and a linker group optionally attached to a solid support;
or two or more of said R¹⁻¹³ and R¹⁶⁻¹⁸ groups are linked, together with the carbons to which they are attached, to form a cyclic saturated or unsaturated hydrocarbon group;
R¹⁴, R¹⁵, R¹⁹, R²⁰ and R³²⁻³⁷ are each independently selected from H, C₁₋₆-alkyl, C₂₋₆-alkenyl, C₂₋₆-alkynyl, aryl, C₁₋₆-haloalkyl, and a linker group optionally attached to a solid support.

In one preferred embodiment of the invention, the compound of formula (I) is a compound of formula (VIII):

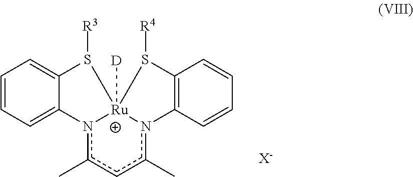

wherein R₃, R₄, D and X⁻ are as defined as above.

In one particularly preferred embodiment, the complex of formula (I) is of formula (VIII) as defined above, wherein:

X⁻ is an anion selected from Cl⁻ and TfO⁻;
D is optional and is selected from (VI) and (VII),

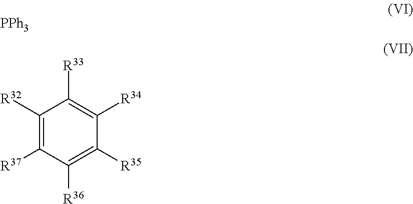

R³ and R⁴ are each independently selected from H, C₁₋₆-alkyl, aryl and C₁₋₆-haloalkyl, and a linker group optionally attached to a solid support.

In one preferred embodiment of the invention,
(i) D is η⁶-C₆H₆, and X⁻ is Cl⁻;
(ii) D is η⁶-C₆H₆, and X⁻ is OTf⁻;
(iii) D is absent, and X⁻ is Cl⁻;
(iv) D is absent, and X⁻ is OTf⁻;
(v) D is PPh₃, and X⁻ is Cl⁻;
(vi) D is PPh₃, and X⁻ is OTf⁻; or
(vii) D is absent, and X⁻ is Br.

Where D is present, the first step in the reaction is the loss of this ligand to form a precursor. The precursor so formed is then capable of interacting with the substrate of formula (II).

In one particularly preferred embodiment of the invention, the compound of formula (I) is a compound of formulas (IXa-IXb) selected from the following:

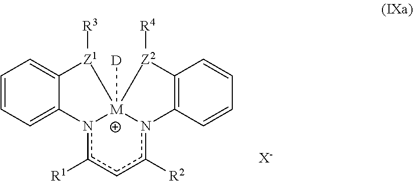

Compound 6a: M=Ru; D=η⁶-C₆H₆; Z¹⁻²=S; R¹⁻⁴=CH₃; X⁻=Cl⁻
Compound 6b: M=Ru; D=η⁶-C₆H₆; Z¹⁻²=S; R¹⁻²=CH₃; R³⁻⁴=CH₂CH₃; X⁻=OTF⁻
Compound 6c: M=Ru; D=none; Z¹⁻²=S; R¹⁻²=CH₃; R³⁻⁴=CH₂CH₃; X⁻=Cl⁻
Compound 6d: M=Ru; D=η⁶-C₆H₆; Z¹⁻²=O; R¹⁻⁴=CH₃; X⁻=OTF⁻
Compound 6e: M=Ru; D=η⁶-C₆H₆; Z¹⁻²=S; R¹⁻⁴=CH₃; X⁻=OTf⁻
Compound 6f: M=Ru; D=none; Z¹⁻²=S; R¹⁻⁴=CH₃; X⁻=OTf⁻
Compound 6g: M=Ru; D=η⁶-C₆H₆; Z¹⁻²=S; R¹⁻²=CH₃; R³⁻⁴=CH₂CH₃; X⁻=OTF⁻
Compound 6h: M=Ru; D=none; Z¹⁻²=S; R¹⁻²=CH₃; R³⁻⁴=CH₂CH₃; X⁻=OTf⁻
Compound 6i: M=Ru; D=η⁶-C₆H₆; Z¹⁻²=O; R¹⁻⁴=CH₃; X⁻=OTf⁻
Compound 6j: M=Ru; D=PPh₃; Z¹⁻²=S; R¹⁻⁴=CH₃; X⁻=Cl⁻
Compound 6k: M=Ru; D=PPh₃; Z¹⁻²=S; R¹⁻⁴=CH₃; X⁻=OTf

Compound 6l: M=Ni; D=none; Z¹⁻²=S; R¹⁻⁴=CH₃; X⁻=Br⁻

Compound 6m: M=Ni; D=none; Z¹⁻²=S; R¹⁻⁴=CH₃; X⁻=PF₆⁻
Compound 6n: M=Ni; D=none; Z¹⁻²=S; R¹⁻²=CH₃; R³ and R⁴ together=CH₂CH₂; X⁻=PF₆⁻
Compound 6q: M=Ru; D=PPh₃; Z¹⁻²=S; R¹⁻²=H; R³⁻⁴=CH₃; X⁻=OTf⁻
Compound 6r: M=Ru; D=PPh₃; Z¹⁻²=S; R¹⁻²=H; R³⁻⁴=CH₃; X⁻=Cl⁻

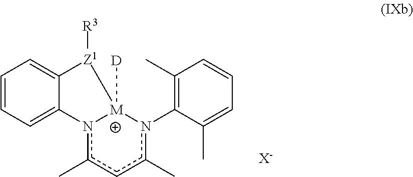

Compound 6o: M=Ru; D=η⁶-C₆H₆; Z¹=S; R³=CH₃; X⁻=Cl⁻
Compound 6p: M=Ru; D=η⁶-C₆H₆; Z¹=S; R³=CH₃; X⁻=OTf⁻

In one highly preferred embodiment of the invention, the complex of formula (I) is a compound of formula (X) selected from the following:

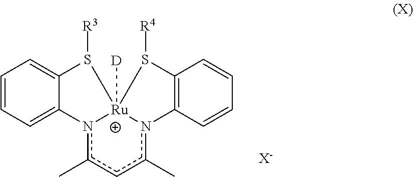

Compound 6e: D=η⁶-C₆H₆; R³⁻⁴=CH₃; X⁻=OTf⁻
Compound 6g: D=η⁶-C₆H₆; R³⁻⁴=CH₂CH₃; X⁻=OTf⁻
Compound 6j: D=PPh₃; R³⁴=CH₃; X⁻=Cl⁻
Compound 6k: D=PPh₃; R³⁻⁴=CH₃; X⁻=OTf⁻

In another preferred embodiment, the compound of formula (I) is selected from the following:

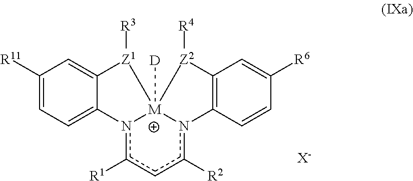

Compound 6a: M=Ru; D=η⁶-C₆H₆; Z¹⁻²=S; R¹⁻⁴=CH₃; R^{6,11}=H; X⁻=Cl⁻
Compound 6b: M=Ru; D=η⁶-C₆H₆; Z¹⁻²=S; R¹⁻²=CH₃; R³⁻⁴=CH₂CH₃; R^{6,11}=H; X⁻=Cl⁻
Compound 6c: M=Ru; D=none; Z¹⁻²=S; R¹⁻²=CH₃; R³⁻⁴=CH₂CH₃; R^{6,11}=H; X⁻=Cl⁻
Compound 6d: M=Ru; D=η⁶-C₆H₆; Z¹⁻²=O; R¹⁻⁴=CH₃; R^{6,11}=H; X⁻=Cl⁻
Compound 6e: M=Ru; D=η⁶-C₆H₆; Z¹⁻²=S; R¹⁻⁴=CH₃; R^{6,11}=H; X⁻=OTf⁻
Compound 6f: M=Ru; D=none; Z¹⁻²=S; R¹⁻⁴=CH₃; R^{6,11}=H; X⁻=⁻OTf
Compound 6g: M=Ru; D=η⁶-C₆H₆; Z¹⁻²=S; R¹⁻²=CH₃; R³⁻⁴=CH₂CH₃; R^{6,11}=H; X⁻=⁻OTf
Compound 6h: M=Ru; D=none; Z¹⁻²=S; R¹⁻²=CH₃; R³⁻⁴=CH₂CH₃; R^{6,11}=H; X⁻=⁻OTf
Compound 6i: M=Ru; D=η⁶-C₆H₆; Z¹⁻²=O; R¹⁻⁴=CH₃; R^{6,11}=H; X⁻=⁻OTf
Compound 6j: M=Ru; D=PPh₃; Z¹⁻²=S; R¹⁻⁴=CH₃; R^{6,11}=H; X⁻=Cl⁻
Compound 6k: M=Ru; D=PPh₃; Z¹⁻²=S; R¹⁻⁴=CH₃; R^{6,11}=H; X⁻=⁻OTf

Compound 6l: M=Ni; D=none; Z¹⁻²=S; R¹⁴=CH₃; R^{6,11}=H; X⁻=Br⁻

Compound 6m: M=Ni; D=none; Z¹⁻²=S; R¹⁻⁴=CH₃; R^{6,11}=H; X⁻=PF₆⁻
Compound 6n: M=Ni; D=none; Z¹⁻²=S; R¹⁻²=CH₃; R³ and R⁴ together=CH₂CH₂; R^{6,11}=H; X⁻=PF₆⁻
Compound 6q: M=Ru; D=PPh₃; Z¹⁻²=S; R^{1-2,6,11}=m H; R³⁻⁴=CH₃; X⁻=⁻OTf
Compound 6r: M=Ru; D=PPh₃; Z¹⁻²=S; R^{1-2,6,11}=H; R³⁻⁴=CH₃; X⁻=Cl⁻
Compound 11a: M=Ru; D=η⁶-C₆H₆; Z¹⁻²=S; R^{1-4,6,11}=CH₃; X⁻=⁻OTf
Compound 11b: M=Ru; D=none; Z¹⁻²=S; R^{1-4,6,11}=CH₃; X⁻=⁻OTf
Compound 11c: M=Ru; D=η⁶-(p-cymene); Z¹⁻²=S; R¹⁻⁴=CH₃; R^{6,11}=H; X⁻=⁻OTf
Compound 11d: M=Ru; D=η⁶-[C₆(CH₃)₆]; Z¹⁻²=S; R¹⁻⁴=CH₃; R^{6,11}=H; X⁻=⁻OTf
Compound 11e: M=Ru; D=η⁶-C₆H₆; Z¹⁻²=S; R¹⁴=CH₃; R^{6,11}=H; X⁻=[(3,5-(CF₃)₂C₆H₃)₄B]⁻
Compound 11f: M=Ru; D=η⁶-C₆H₆; Z¹⁻²=S; R¹⁻⁴=CH₃; R^{6,11}=H; X⁻=SbF₆⁻
Compound 11g: M=Os; D=η⁶-C₆H₆; Z¹⁻²=S; R¹⁴=CH₃; R^{6,11}=H; X⁻=⁻OTf
Compound 11h: M=Os; D=none; Z¹⁻²=S; R¹⁴=CH₃; R^{6,11}=H; X⁻=⁻OTf

In another preferred embodiment, the compound of formula (I) is selected from the following:

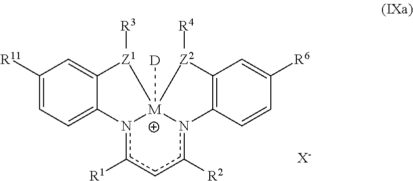

Compound 6e: M=Ru; D=η⁶-C₆H₆; Z¹⁻²=S; R¹⁻⁴=CH₃; R^{6,11}=H; X⁻=⁻OTf
Compound 6f: M=Ru; D=none; Z¹⁻²=S; R¹⁻⁴=CH₃; R^{6,11}=H; X⁻=⁻OTf
Compound 6g: M=Ru; D=η⁶-C₆H₆; Z¹⁻²=S; R¹⁻²=CH₃; R³⁻⁴=CH₂CH₃; R^{6,11}=H; X⁻=⁻OTf
Compound 6h: M=Ru; D=none; Z¹⁻²=S; R¹⁻²=CH₃; R³⁻⁴=CH₂CH₃; R^{6,11}=H; X⁻=⁻OTf
Compound 6j: M=Ru; D=PPh₃; Z¹⁻²=S; R¹⁻⁴=CH₃; R^{6,11}=H; X⁻=Cl⁻
Compound 6k: M=Ru; D=PPh₃; Z¹⁻²=S; R¹⁻⁴=CH₃; R^{6,11}=H; X⁻=⁻OTf
Compound 11a: M=Ru; D=η⁶-C₆H₆; Z¹⁻²=S; R^{1-4,6,11}=CH₃; X⁻=⁻OTf
Compound 11b: M=Ru; D=none; Z¹⁻²=S; R^{1-4,6,11}=CH₃; X⁻=⁻OTf
Compound 11c: M=Ru; D=η⁶-(p-cymene); Z¹⁻²=S; R¹⁻⁴=CH₃; R^{6,11}=H; X⁻=⁻OTf
Compound 11d: M=Ru; D=η⁶-[C₆(CH₃)₆]; Z¹⁻²=S; =CH₃; R^{6,11}=H; X⁻=⁻OTf
Compound 11e: M=Ru; D=η⁶-C₆H₆; Z¹⁻²=S; R¹⁻⁴=CH₃; R^{6,11}=H; X⁻=[(3,5-(CF₃)₂C₆H₃)₄B]⁻
Compound 11f: M=Ru; D=η⁶-C₆H₆; Z¹⁻²=S; R¹⁻⁴=CH₃; R^{6,11}=H; X⁻=SbF₆⁻

As used herein, the complex of formula (I) is derived from a precursor that is a β-diketiminate-type ligand. Deprotonation of the structure shown on the left below (a β-diketimine type ligand) gives rise to a β-diketiminate-type ligand as shown on the right below, that is conventionally represented with the dashed lines showing a delocalisation of the negative charge. The negative charge may of course be further delocalised over the molecule, depending on the nature of the A and B rings.

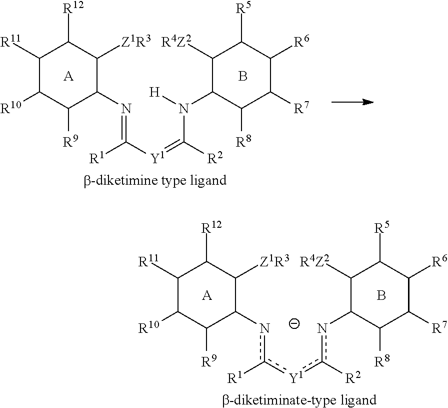

The β-diketiminate-type ligand is capable of forming a complex with Ru(II), Os(II) or Fe(II), for example, an η⁶-arene p-diketiminato-ruthenium complex, an η⁶-arene β-diketiminato-osmium complex or an η⁶-arene β-diketiminato-iron complex. Throughout the specification, the coordination between the metal M and the donor ligand D (e.g., η⁶-arene) is represented as a dashed line.

In one preferred embodiment, the complex of formula (I) is anchored to a solid support, for example, a polymer, thereby facilitating easy separation of the spent materials. Suitable solid supports will be familiar to one of ordinary skill in the art. Likewise, suitable linker groups for attaching the complex of formula (I) to the solid support will also be familiar to the skilled artisan.

The post-grafting of the catalyst to an insoluble solid surface is preferably achieved via attachment through one or more of the groups R¹-R²⁰, i.e. one or more of the groups R¹-R²⁰ is a linker group optionally attached to a solid support.

Preferably, the insoluble solid surface is mesoporous silica, e.g. MCM-41 containing hexagonal channels.

Preferably, the complex of formula (I) is anchored to the solid surface via a linear silanol alkyl tether.

The complex of formula (I) may be prepared and isolated prior to use in the process of the invention, or may be generated in situ.

Another aspect of the invention relates to specific complexes of formula (VII) selected from the following:

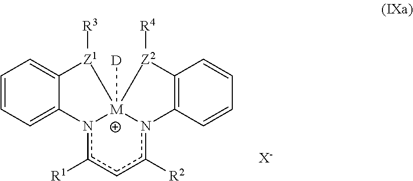

Compound 6a: M=Ru; D=η⁶-C₆H₆; Z¹⁻²=S; R¹⁻⁴=CH₃; X⁻=Cl⁻
Compound 6b: M=Ru; D=η⁶-C₆H₆; Z¹⁻²=S; R¹⁻²=CH₃; R³⁻⁴=CH₂CH₃; X⁻=Cl⁻
Compound 6c: M=Ru; D=none; Z¹⁻²=S; R¹⁻²=CH₃; R³⁻⁴=CH₂CH₃; X⁻=Cl⁻
Compound 6d: M=Ru; D=η⁶-C₆H₆; Z¹⁻²=O; R¹⁻⁴=CH₃; X⁻=Cl⁻
Compound 6e: M=Ru; D=η⁶-C₆H₆; Z¹⁻²=S; R¹⁻⁴=CH₃; X⁻=OTf⁻
Compound 6f: M=Ru; D=none; Z¹⁻²=S; R¹⁻⁴=CH₃; X⁻=OTf⁻
Compound 6g: M=Ru; D=η⁶-C₆H₆; Z¹⁻²=S; R¹⁻²=CH₃; R³⁻⁴=CH₂CH₃; X⁻=OTf⁻
Compound 6h: M=Ru; D=none; Z¹⁻²=S; R¹⁻²=CH₃; R³⁻⁴=CH₂CH₃; X⁻=OTf⁻
Compound 6i: M=Ru; D=η⁶-C₆H₆; Z¹⁻²=O; R¹⁻⁴=CH₃; X⁻=OTf⁻
Compound 6j: M=Ru; D=PPh₃; Z¹⁻²=S; R¹⁻⁴=CH₃; X⁻=Cl⁻
Compound 6k: M=Ru; D=PPh₃; Z¹⁻²=S; R¹⁻⁴=CH₃; X⁻=OTf⁻
Compound 6l: M=Ni; D=none; Z¹⁻²=S; R¹⁻⁴=CH₃; X⁻=Br⁻
Compound 6m: M=Ni; D=none; Z¹⁻²=S; R¹⁻⁴=CH₃; X⁻=PF₆
Compound 6n: M=Ni; D=none; Z¹⁻²=S; R¹⁻²=CH₃; R³ and R⁴ together=CH₂CH₂; X⁻=PF₆⁻
Compound 6q: M=Ru; D=PPh₃; Z¹⁻²=S; R¹⁻²=H; R³⁻⁴=CH₃; X⁻=OTf⁻
Compound 6r: M=Ru; D=PPh₃; Z¹⁻²=S; R¹⁻²=H; R³⁻⁴=CH₃; X⁻=Cl⁻

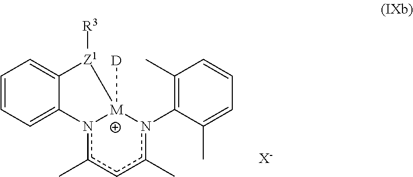

Compound 6o: M=Ru; D=η⁶-C₆H₆; Z¹=S; R³=CH₃; X⁻=Cl
Compound 6p: M=Ru; D=η⁶-C₆H₆; Z¹=S; R³=CH₃; X⁻=OTf

Another preferred embodiment of the invention relates to a complex selected from 6a-6r and 11a to 11h as defined above. More preferably, the complex is selected from 6e-6h, 6j, 6k and 11a-f.

### Process

The process of the reaction is typically carried out using a suitable solvent system. Preferably, the substrate of formula (II) is dissolved or slurried in a polar, non-protic solvent. Non-limiting examples of such solvents include toluene, chlorinated and fluorinated solvents such as methylene chloride and 1,2-dichlorobenzene, and ethereal solvents such as tetrahydrofuran (THF), 1,2-dimethoxyethane, diglyme and polyethylene glycol dimethyl ether. Such solvents may be used either individually or in combination with each other. Particularly preferred solvents include THF, 1-butyl-3-methylimidazolium tetrafluoroborate (BmimBF₄), 1-ethyl-3-methylimidazolium trifluoromethanesulfonate, 1-butyl-3-methylimidazolium trifluoromethanesulfonate, 1-butyl-3-methylimidazolium chloride (BmimCl) and 1-butyl-3-methylimidazolium bromide (BmimBr). Particularly preferred fluorinated solvents include α,α,α-trifluorotoluene.

In one highly preferred embodiment, the solvent is selected from THF, 1-butyl-3-methylimidazolium tetrafluoroborate (BmimBF₄), 1-butyl-3-methylimidazolium chloride (BmimCl) and 1-butyl-3-methylimidazolium bromide (BmimBr).

Preferably, the process of the invention uses a non-volatile solvent, so that only dihydrogen is liberated during the reaction.

Preferably, the process of the invention takes place in a homogeneous mixture, i.e. preferably the complex of formula (I) is essentially soluble in the reaction solvent(s) and remains essentially in solution through the reaction process with minimal amounts of precipitation.

In another preferred embodiment, the process takes place without additional solvent. In that case, the substrate (II) is either liquid at the reaction temperature or in an mixture with the catalyst (I) or in a mixture of different substrates according to formula (II) due to melting point reduction in mixtures.

In one preferred embodiment, the solvent is a mixture of THF and dimethoxyethane. Preferably, the ratio of THF and dimethoxyethane is from about 4:1 to about 3:1.

Preferably, the complex of formula (I) is dissolved or slurried in solution with the same solvent as that used to dissolve or slurry the substrate of formula (II).

The catalyst to substrate ratio directly controls the rate of hydrogen released.

Preferably, the process of the invention is carried out at close to atmospheric pressure.

Advantageously, the process can be carried out without the need for an external heat source. Preferably, the process of the invention is carried out at a temperature of at least 0° C.

In one preferred embodiment, the process is carried out at room temperature (approximately 25° C.).

In another preferred embodiment, the process is carried out at a temperature of from about 20° C. to about 50° C., preferably from about 25° C. to about 45° C., more preferably from about 30° C. to about 45° C., more preferably still from about 35° C. to about 45° C., even more preferably from about 40° C. to about 45° C.

In another preferred embodiment, the process is carried out at a temperature of from about 50° C. to about 80° C., preferably from about 60° C. to about 80° C., more preferably from about 65° C. to about 80° C., more preferably still from about 65° C. to about 75° C., even more preferably from about 70° C. to about 75° C.

The hydrogen that is generated in the process of the invention may be optionally captured using any known means. The reaction may be performed in air, but may also be performed in an inert atmosphere, for example, under argon or neon, or under hydrogen.

Preferably, the process of the invention is carried out in the absence of oxygen.

Preferably, the process of the invention is carried out in an inert atmosphere.

Surprisingly, the process of the invention can also be carried out in the presence of oxygen and/or water in the atmosphere. Thus, in one preferred embodiment, the process of the invention is carried out in the presence of oxygen. In another preferred embodiment, the process of the invention is carried out in the presence of oxygen and atmospheric water.

### Hydrogen Generation System

There are expected to be many applications for the process of the present disclosure. In one embodiment, the process of the invention is used to generate hydrogen, which is supplied to a hydrogen fuel cell, such as a PEMFC. Hydrogen generators may include a first compartment holding a catalyst-comprising solution and a second compartment holding the one or more substrates of formula (II) as defined above.

A further aspect of the invention therefore relates to a hydrogen generation system comprising:

(a) at least one complex of formula (I)

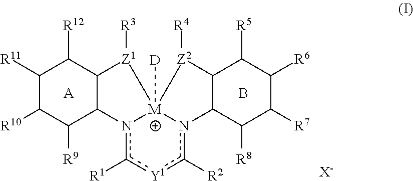

wherein:
X⁻ is an anion;
M is a metal selected from Ru, Os, Fe, Co and Ni;
D is optionally present and is one or more monodentate or multidentate donor ligands;
Y¹ is selected from CR¹³, B and N;
Z¹ and Z² are each independently selected from ═N, ═P, NR¹⁴, PR¹⁵, O, S and Se; or
Z² is a direct bond between carbocyclic ring B and substituent R⁴;
each of A and B is independently a saturated, unsaturated or partially unsaturated carbocyclic hydrocarbon ring;
R³ and R⁴ are each independently selected from H, C₁₋₆-alkyl, aryl and C₁₋₆-haloalkyl, and a linker group optionally attached to a solid support; or
R³ and R⁴ together form the following moiety:

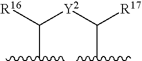

Y² is a direct single bond or double bond, or is CR¹⁸;
R¹, R², R⁵⁻¹³ and R¹⁶⁻¹⁸ are each independently selected from H, C₁₋₆-alkyl, C₂₋₆-alkenyl, C₂₋₆-alkynyl, aryl, C₁₋₆-haloalkyl, NR¹⁹R²⁰ and a linker group optionally attached to a solid support;
or two or more of said R¹⁻¹³ and R¹⁶⁻¹⁸ groups are linked, together with the carbons to which they are attached, to form a saturated or unsaturated hydrocarbon group;
R¹⁴, R¹⁵, R¹⁹ and R²⁰ are each independently selected from H, C₁₋₆-alkyl, C₂₋₆-alkenyl, C₂₋₆-alkynyl, aryl, C₁₋₆-haloalkyl, and a linker group optionally attached to a solid support;
(b) at least one substrate of formula (II)

R²¹R²²NH—BHR²³R²⁴ (II)

wherein R²¹ to R²⁴ are each independently selected from H, C₁₋₆-alkyl, fluoro-substituted C₁₋₆-alkyl, C₆₋₁₄-aryl and C₆₋₁₄-aralkyl, or any two of R²¹, R²², R²³ and R²⁴ are linked to form a C₃₋₁₀-alkylene group or C₃₋₁₀-alkenylene group, which together with the nitrogen and/or boron atoms to which they are attached, forms a cyclic group;
or a substrate comprising two, three or four substrates of formula (II) linked via one or more bridging groups so as to form a dimeric, trimeric or tetrameric species, and wherein the bridging group is selected from straight or branched C₁₋₆-alkylene optionally substituted by one or more fluoro groups; boron; C₆₋₁₄-aryl; and C₆₋₁₄-aralkyl;
or a substrate comprising two, three or four substrates of formula (II) which are joined so as to form a fused cyclic dimeric, trimeric or tetrameric species; and
(c) optionally, a solvent.

In one preferred embodiment of the invention, the hydrogen generation system comprises a first compartment comprising the at least one complex of formula (I), a second compartment comprising the at least one substrate of formula (II), wherein the first or second compartment further comprises a solvent and/or a means for combining the contents of the first compartment with the contents of the second compartment such that when the contents are combined, hydrogen is generated.

More preferably, the hydrogen generation system further comprises at least one flow controller to control a flow rate of the at least one complex of formula (I) or the at least one substrate of formula (II).

Preferably, control electronics are coupled to substrate mass flow controllers and hydrogen mass flow controllers. Mass flow controllers control the flow of the substrate solution, which enters the first compartment to achieve a desired hydrogen flow generated by the hydrogen generator. The catalyst contained in the first compartment may be tethered to a surface by a linker.

In one preferred embodiment, the at least one substrate of formula (II) is stored in a separated compartment as a solid, a liquid or as a solution in a solvent. In operation, as soon as the hydrogen generator is turned on, control electronics send a signal to a mass flow controller (or a flow controller) to allow a predetermined flow rate of the at least one substrate of formula (II) in a solvent (or in its liquid form) in a second compartment to flow into the first compartment which holds the complex of formula (I). As a result, hydrogen gas is generated. The reaction by-products are captured and remain in the first compartment. In alternate embodiments the complex of formula (I) in the solvent can be provided in the second compartment and be pumped into the first compartment holding the substrate of formula (II).

The hydrogen generation system is preferably in the form of a self-contained reaction vessel that is attached via a vent to any application requiring a source of hydrogen gas, for example, a chemical reaction, a fuel cell, or the like. Suitable fuel cells will be familiar to one skilled in the art and include any fuel cells that can use hydrogen as a fuel source, for example, internal combustion engines (ICE), solid oxide fuel cells (SOFC), phosphoric acid fuel cells (PAFC), alkaline fuel cells (AFC) and molten carbonate fuel cells (MCFC).

In one particularly preferred embodiment of the invention, the hydrogen generation system is connected to a proton exchange membrane fuel cell (PEMFC). More preferably, a coupling connector delivers hydrogen generated by hydrogen generator to the anode of a PEMFC.

The hydrogen generators disclosed herein are capable of delivering PEMFC grade hydrogen at low reaction temperatures, safely and reliably. Such hydrogen PEM fuel cells are optimal for applications where batteries and internal combustion engines do not deliver cost-effective and convenient power generation solutions. Advantageously, the hydrogen generators disclosed herein provide a constant source of power in a compact size that does not require electrical recharging.

Another aspect of the invention relates to the use of at least one complex of formula (I) as defined above in a fuel cell.

Another aspect of the invention relates to a fuel cell comprising at least one complex of formula (I) as defined above. Preferably, the fuel cell further comprises a substrate of formula (II) as defined above, and optionally a suitable solvent.

Another aspect of the invention relates to a method of thermolytically dehydrogenating a substrate of formula (II) as described above, said method comprising contacting at least one substrate of formula (II) with a complex of formula (I) in the presence of a solvent.

Another aspect of the invention relates to the use of at least one complex of formula (I) as defined above in a method of thermolytically dehydrogenating a substrate of formula (II) as described above.

Another aspect of the invention relates to the use of at least one complex of formula (I) as defined above in a method of producing hydrogen. Preferably, the complex of formula (I) is used in conjunction with a substrate of formula (II) as defined above.

Another aspect of the invention relates to a method of using a hydrogen generation system as defined above which comprises modulating the hydrogen pressure in said system so as to modulate activity of the at least one complex of formula (I).

The present invention is further illustrated by way of the following non-limiting examples, and with reference to the following Figures, wherein:

FIG. 1 shows the results of a pressure reactor study of hydrogen equivalents released versus time (h), for the dehydrogenation of ammonia borane in THF at 42° C. with (i) compound 6k, and (ii) catalyst 7. The third trace is for the control experiment carried out in THF in the absence of catalyst.

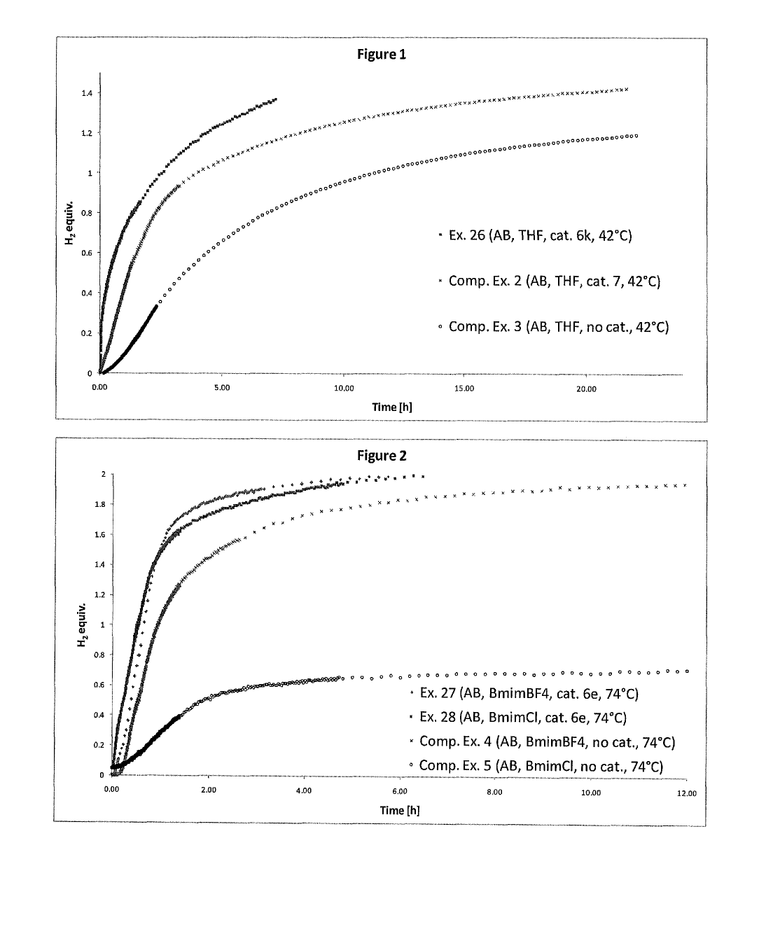

FIG. 2 shows the results of a pressure reactor study of hydrogen equivalents released versus time (h), for the dehydrogenation of ammonia borane in BmimBF₄ or BmimCl at 74° C. with compound 6e versus controls.

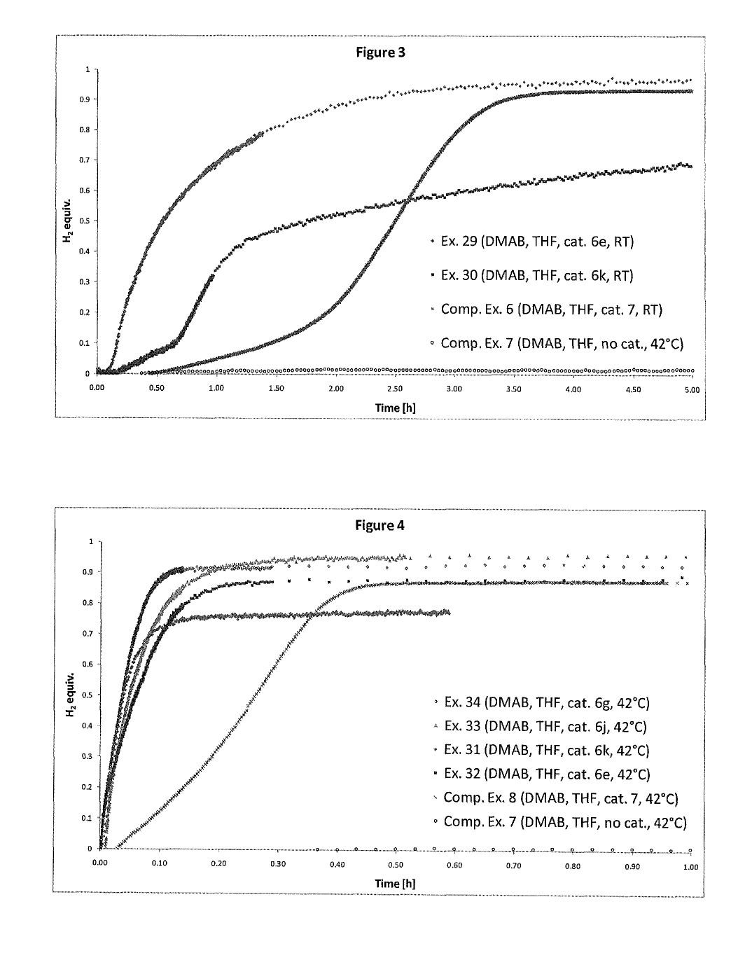

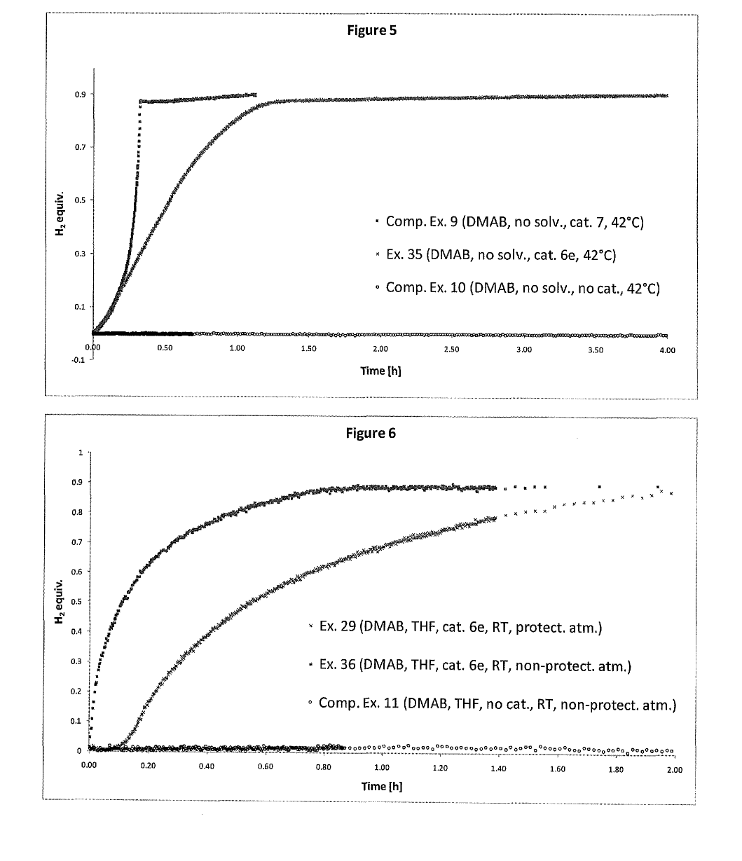

FIG. 3 shows the results of a pressure reactor study of hydrogen equivalents released versus time (h), for the dehydrogenation of DMAB in THF at room temperature with (i) compound 6e, (ii) compound 6k, and (iii) catalyst 7, versus control (absence of catalyst).

FIG. 4 shows the results of a pressure reactor study of hydrogen equivalents released versus time (h), for the dehydrogenation of DMAB in THF at 42° C. for catalysts 6e, 6g, 6j, 6k and catalyst 7 versus control (absence of catalyst).

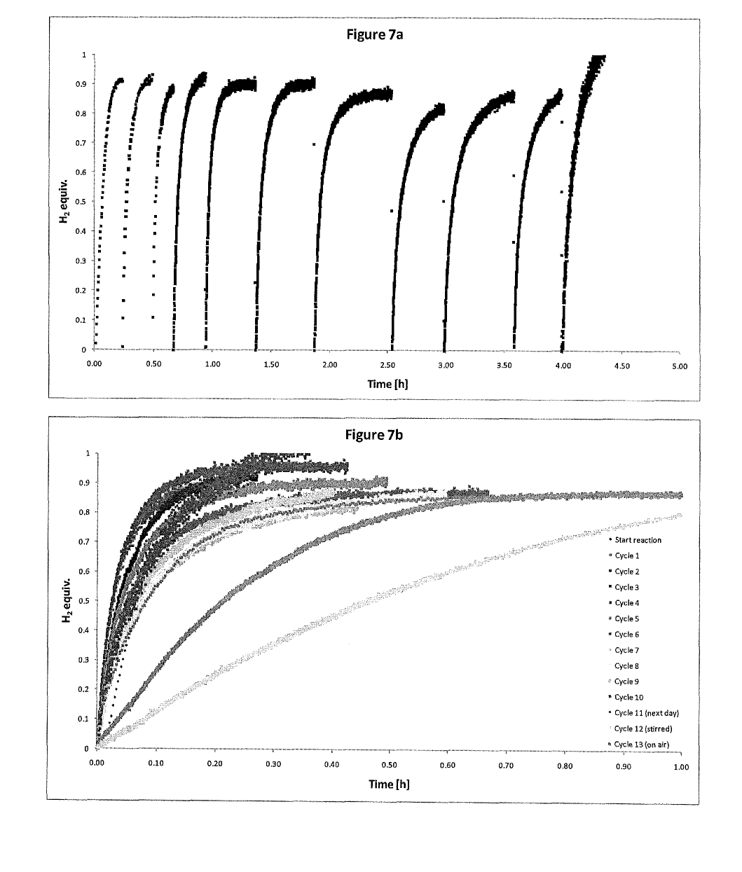

FIG. 5 shows the results of a pressure reactor study of hydrogen equivalents released versus time (h), for the solvent-free dehydrogenation of DMAB at 42° C. with catalyst 6e and catalyst 7 versus control (absence of catalyst).

FIG. 6 shows the results of a pressure reactor study of hydrogen equivalents released versus time (h), for the dehydrogenation of DMAB in THF at room temperature with catalyst 6e under non-protective atmosphere versus control (protective atmosphere, and absence of catalyst).

FIGS. 7a and 7b show the results of a pressure reactor study of hydrogen equivalents (based on the amounts of substrate) released versus time (h), for the dehydrogenation of DMAB in THF 42° C. with catalyst 6e under addition of further aliquots of DMAB/THF solution.

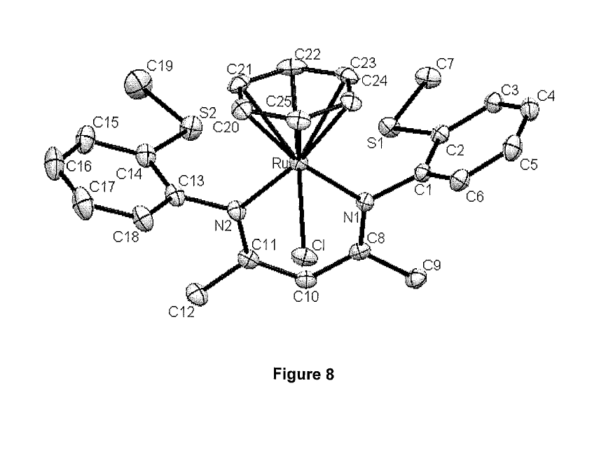

FIG. 8 shows the structure of (η⁶-benzene)-ruthenium(II)-κ²N,N′—N,N′-bis(2-methylthiophenyl)-1,3-diketiminato chloride (6a).

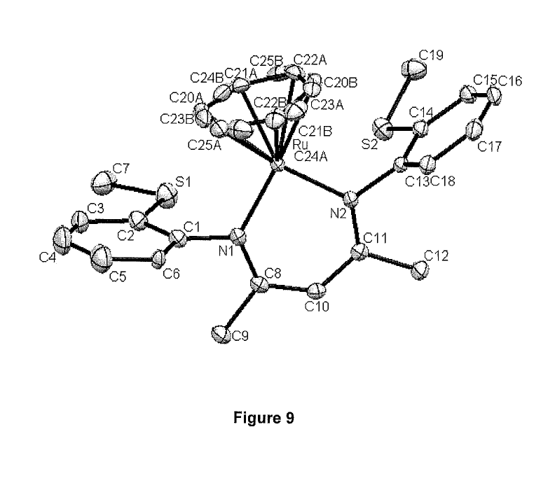

FIG. 9 shows the structure of (η⁶-benzene)ruthenium(II)-κ²N,N′—N,N′-bis(2-methylthiophenyl)-1,3-diketiminato trifluoromethanesulfonate (6e). The anion is omitted for clarity.

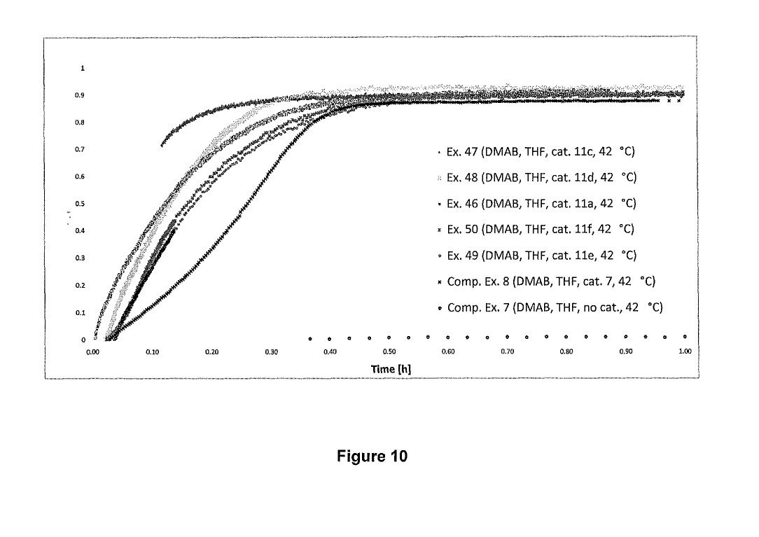

FIG. 10 shows the results of a pressure reactor study of hydrogen equivalents released versus time (h), for the dehydrogenation of DMAB in THF at 42° C. for catalysts 11a, 11c, 11d, 11e, 11f and catalyst 7 versus control (absence of catalyst).

### EXAMPLES

### Example 1

### Preparation of Catalyst

### General Procedures

The synthesis of the starting materials and the catalysts was carried out under a purified N₂ atmosphere with standard Schlenk techniques, whereas subsequent synthesis and manipulations of all products and reagents were performed in a dry box with a N₂ atmosphere containing less than 1 ppm of O₂ and H₂O and equipped with a vacuum outlet. All glassware was pre-dried and the flasks underwent several purge/refill cycles before the introduction of solvents or reagents. All solvents were dried according to literature procedures involving distillation over the appropriate drying agents and then stored in Schlenk flasks equipped with teflon stopcocks. Celite powder for filtration was kept in an oven at 130° C. prior to use. All other reagents and gases (technical grade) were purchased from commercial sources and used as received if not specified differently. All reactions involving silver salts were carried out in the dark (i.e., vessels were covered with aluminium foil). NMR spectra were recorded using either a Varian 300, 400, 500 or 600 MHz instruments. If necessary, ¹H (COSY, NOE), ¹³C (HMBC and HSQC) one- and two-dimensional spectra were used to assign molecular connectivity and conformation in solution. Deuterated dichloromethane was distilled over CaH₂ and stored in the glove-box. Anhydrous THF-d₈ was purchased in sealed ampoules from Apollo Scientific and used as received. Chemical shifts for ¹H, ¹³C, ¹⁹F, and ¹¹B spectra were referenced to Me₄Si or to the appropriate solvent. ESI mass spectra were recorded using a Micromass Quattro micro instrument.

### Examples for Synthesis of Ligands

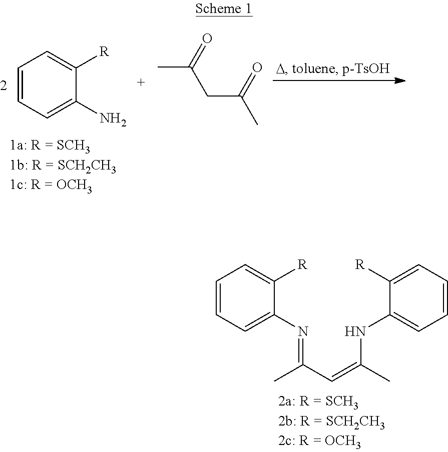

### Example 1

### Synthesis of Ligand 2a (Scheme 1)

### N,N′-Bis(2-methylthiophenyl)-2,4-dimethyl-1,3-diketimine (2a) CAS 1198159-02-2

Compound 2a has been described by Pfirrmann et al (Z. Anorg. Allg. Chem. 2009, 635, 312-316). We describe a slightly modified procedure with improved yield. Acetylacetone (1.14 mL, 11.1 mmol) and p-toluenesulfonic acid monohydrate (4.23 g, 22.2 mmol) were added to a 3-neck round-bottom flask with a Dean-Stark apparatus connected. Degassed toluene (150 mL) and 2-methylthioaniline 1a (3.35 mL, 26.75 mmol) were added to give a green solution, and the mixture refluxed at 150° C. for 24 hours. The resulting yellow solution was cooled, and solvent removed. The resulting oil was taken up in dichloromethane (100 ml) and stirred with a solution of sodium carbonate (40 g in 100 ml H₂O) for 30 minutes. The organic layer was separated and the aqueous layer extracted with dichloromethane (3×50 mL), the organic layers were combined, washed with brine, and dried over magnesium sulfate. The solvent was removed to give a yellow oil. Recrystallization from methanol gave 2a as yellow crystals (2.41 g, 64%).

¹H & ¹³C NMR analytical data as described in the literature. Anal. Found [Calc.] C: 66.95 [66.64], H: 6.54 [6.48], N: 8.05 [8.18]. ESI-MS (25° C., CH₃CN), (m/z) positive mode 343.08 [parent+H⁺, 100%].

### Example 2

### Synthesis of Ligand 2b (Scheme 1)

### N,N′-Bis(2-ethylthiophenyl)-2,4-dimethyl-1,3-diketimine (2b)

The synthesis follows the synthesis for 2a by Pfirrmann et al (Z. Anorg. Allg. Chem. 2009, 635, 312-316). Acetylacetone (1.98 g, 19.7 mmol) and p-toluenesulfonic acid monohydrate (3.76 g, 19.7 mmol) were added to a 3-neck round bottom flask with a Dean-Stark apparatus connected. Degassed toluene (150 mL) and 2-ethylthioaniline 1b (6.06 g, 39.55 mmol) were added to give a brown solution, and the mixture refluxed at 150° C. for 24 hours. The resulting purple solution was cooled, and solvent removed. Saturated sodium carbonate (40 g in 200 mL water) and dichloromethane (200 mL) was added to this and stirred for 30 minutes, to give an orange solution which was extracted with dichloromethane (3×50 mL), the organic layers were combined, washed with brine, and dried over magnesium sulfate. The solvent was removed to give a yellow oil. A filtration on silica gel was carried out to remove monosubstituted compound with pentane to give 2b as yellow oil (3.3 g, 46%) as a mixture of two isomers.

¹H NMR (400 MHz, CDCl₃) δ ppm: 1.21 (td, 6H, J=7.1 Hz, 3.9 Hz, CH₂CH₃), 1.92 (s, 6H, NCCH₃), 2.83 (q, 4H, J=7.4H, 2×CH₂), 3.70 (q, 4H, J=7.0 Hz, 2×CH₂), 4.94 (s, 1H, (β-CH), 7.0 (m, 8H, Ar—CH), 12.55 (br s, 1H, NH). ESI-MS (25° C., CH₂Cl₂), (m/z) positive mode 371.54 [parent+H⁺, 100%].

### Example 3

### Synthesis of Ligand 2c (Scheme 1)

### N,N′-Bis(2-methoxyphenyl)-2,4-dimethyl-1,3-diketimine (2c) CAS 613685-98-6

Compound 2c has been synthesized according to the procedure described by Carey et al (Dalton Trans. 2003, 1083-1093). The analytical data correspond to the literature.

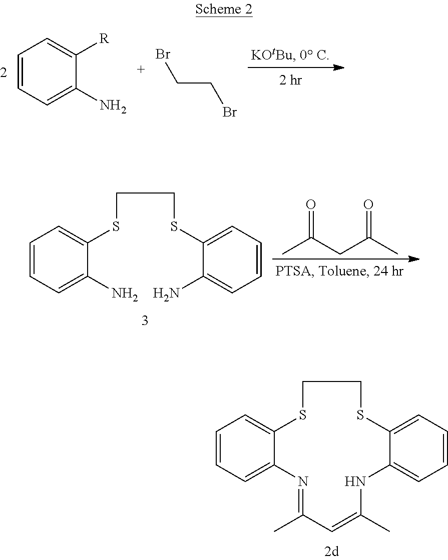

### Example 4

### Synthesis of Ligand 2d (Scheme 2)

### Synthesis of 2,2′-(Ethane-1,2-diyldisulfanediAdianiline (3) CAS 52411-33-3

The synthesis of 3 has been described by Chandra et al (Transition Metal Chemistry 29: 269-275, 2004). We describe a slightly modified procedure with improved yield. 2-Aminothiophenol (2.50 g, 20 mmol) was stirred in dry ethanol (50 mL) and cooled in ice bath. Potassium t-butoxide (2.25 g, 20 mmol) was added portion wise to the solution over 15 minutes and the mixture was stirred for further 45 minutes. 1,2-Dibromoethane (0.864 mL, 10 mmol) was added dropwise to the reaction mixture over 15 minutes. The mixture was allowed to warm at room temperature and then stirred for further 45 minutes. The reaction mixture was filtered, and the filtrate was evaporated to dryness in vacuo. The resulting residue was treated with dichloromethane 100 mL and filtered, and the filtrate was evaporated to dryness under vacuum to give white product 3 (Yield=2.51 g, 91%).

¹H NMR (25° C., 500 MHz, CDCl₃) δ 7.32 (dd, J=7.7, 1.7 Hz, 1H), 7.11 (td, J=7.6, 1.5 Hz, 1H), 6.70 (dd, J=8.2, 1.3 Hz, 1H), 6.66 (td, J=7.3, 1.3 Hz, 2H), 2.86 (s, 4H).

### Synthesis of 2d

p-Toluenesulfonic acid monohydrate (1.43 g, 7.48 mmol) was added to a round bottom flask and set up with Dean-Stark apparatus and the flask was put under nitrogen. Toluene (120, degassed) was added to the solid and then 2,4-pentanedione (375 mg, 3.74 mmol) and 3 (1.0 g, 3.74 mmol) were added and the mixture was refluxed for 20 hours at 140° C. On addition of the aniline derivative the solution went yellow and after 20 hours reflux the solution was bright yellow with a yellow solid. The solvent was removed, and saturated sodium carbonate solution (100 mL) was added to neutralize the acid. It was then extracted with 150 mL dichloromethane and the organic layer was reduced down to 10 mL. Recrystallisation from cold methanol (20 mL) yielded 2d as a yellow powder (640 mg, 50% yield).

¹H NMR (25° C., 300 MHz, CDCl₃) δ (ppm): 12.52 (s, 1H, NH), 6.87-7.04 (m, 8H, Ar CH), 4.88 (s, 1H, β-CH), 2.85 (s, 4H, SCH₂), 1.85 (s, 6H, —CH₃), ¹³C NMR (25° C., 101 MHz, CDCl₃) δ (ppm): 159.85 (N═C), 144.99 (N—C), 129.04, 126.37, 124.11, 123.36 (Ar C), 97.76 (N═C—CH), 31.75 (S—CH₂), 20.96 (N═C—CH₃).

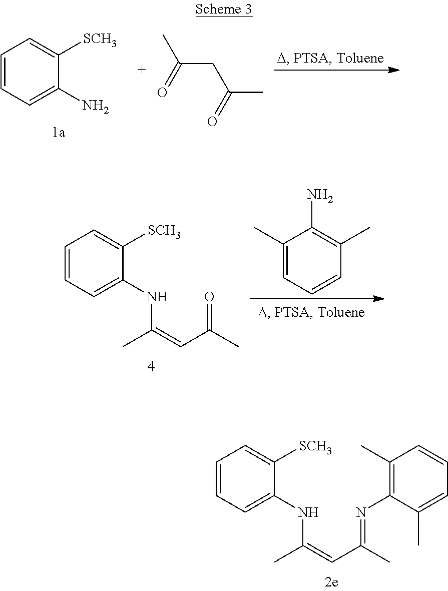

### Example 5

### Synthesis of Ligand 2e (Scheme 3)

### Synthesis of 4

This compound has been described before by Hiraki et al (Bull. Chem. Soc. Japan, 1983, 56, 1410-13). We present an alternative synthesis. Acetylacetone (4.00 g, 39.95 mmol) and p-toluenesulfonic acid monohydrate (0.20 g, 1.05 mmol) were added to a 3-neck round bottom flask with a Dean-Stark apparatus connected. Degassed toluene (150 mL) and 2-methylthioaniline 1a (5 mL, 39.55 mmol) were added to give a red solution, and the mixture refluxed at 150° C. for 24 hours. The resulting purple solution was cooled and extracted with diethyl ether (200 mL). The organic layers were dried over magnesium sulfate. The solvent was removed to give a yellow oil which was recrystallized from ethanol to give 4 as yellow powder (5.89 g, 67%) as a mixture of two isomers.

¹H NMR (400 MHz, CDCl₃) δ ppm: 1.87 (s, 3H, OCCH₃), 2.11 (s, 3H, NCCH₃), 2.41 (s, 3H, SCH₃), 5.23 (s, 1H, (β-CH), 7.09 (m, 1H, o-Ar H), 7.12 (m, 1H, p-Ar H), 7.20 (m, 2H, m-Ar H) 12.26 (br s, 1H, NH). ¹³C NMR (101 MHz, CDCl₃) δ ppm: 15.2 (OCCH₃), 19.5 (NCCH₃), 29.2 (SCH₃), 97.5 ((β-CH), 125.2, 126.2, 126.8, 127.1 (Ar CH), 136.1 (Ar CS), 136.4 (Ar i-C), 160.8 (C═N), 196.4 (C═O). ESI-MS (25° C., CH₂Cl₂), (m/z) positive mode 222.095 [parent+H⁺, 100%]. Anal. Found [Calc.] C: 65.19 [65.12], H: 6.76 [6.83], N: 6.23 [6.34].

### Synthesis of 2e

4 (4.00 g, 18.1 mmol) and p-toluenesulfonic acid monohydrate (3.44 g, 18.1 mmol) were added to a 3-neck round bottom flask with a Dean-Stark apparatus connected. Toluene (150 mL) and 2,6 dimethylaniline (2.19 g, 18.1 mmol) were added to give a yellow mixture which was refluxed at 150° C. for 24 hours. The resulting solution was cooled, and solvent removed. Saturated sodium carbonate (40 g in 200 mL water) and dichloromethane (200 mL) was added to this and stirred for 30 minutes, to give an orange solution which was extracted with dichloromethane (3×50 mL), the organic layers were combined, washed with brine, and dried over magnesium sulfate. The solvent was removed to give a yellow oil. A filtration on silica gel was carried out to remove monosubstituted compound with pentane to give 2e as yellow oil (3.05 g, 52%) as a mixture of isomers.

¹H NMR (400 MHz, CDCl₃) δ ppm: 1.70 (s, 3H, isomer CH₃), 1.93 (s, 3H, CH₃), 2.18 (s, 3H, CH₃), 2.24 (s, 6H, 2×phenyl CH₃), 2.37 (s, 3H, SCH₃), 4.93 (s, 1H, β-CH), 7.09 (m, 1H, o-Ar H), 7.12 (m, 1H, p-Ar H), 7.20 (m, 2H, m-Ar H) 12.25 (br s, 1H, NH).

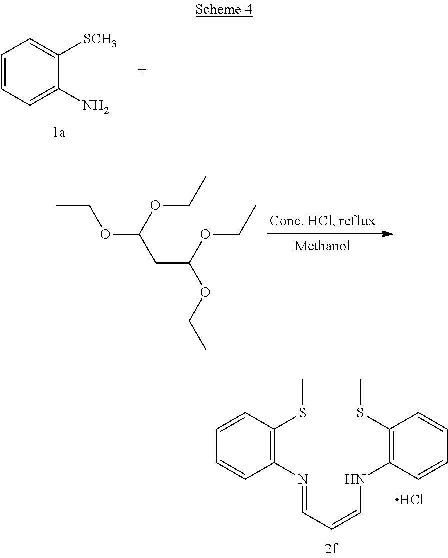 [SMILES: CSc1ccccc1N ; "+" ; CCOC(CC(OCC)OCC)OCC ; CSc1ccccc1/N=C/C=C\Nc1ccccc1SC ; Cl]

### Example 6

### Synthesis of Ligand 2f (Scheme 4)

### N,N′-Bis(2-methylthiophenyl)-1,3-diketimine hydrochloride (20

1,1,3,3-Tetraethoxypropane (1.0 g, 4.5 mmol) and 2-(methylthio)aniline 1a (1.19 g, 9.0 mmol, 2 equiv.) were dissolved in a small volume of hot methanol and the solution was acidified with a 5 mL of concentrated hydrochloric acid diluted 1:1 with methanol (5 mL). A yellow solid of the tri-hydrochloric acid product separated immediately while stirring at room temperature, washed with methanol-ether mixture, filtered and dried under reduced pressure. The yellow solid was dissolved in saturated aq. sodium carbonate solution while stirring and then dropwise addition of triethylamine until the yellow solid dissolved completely. The aq. solution was extracted with dichloromethane (×3), washed with brine, dried with magnesium sulphate, and the solvent was reduced in vacuo to yield 2f as a dark brown oil. Yield=1.54 g, 98%.

¹H NMR (25° C., 300 MHz, CDCl₃) δ (ppm): 11.90 (s, 1H, NH), 7.59 (d, J=5.2 Hz, 2H, α-CH), 7.29 (d, J=7.9 Hz, 2H, Ar CH), 7.16 (d, J=7.8 Hz, 2H, Ar CH), 7.11-6.95 (m, 4H, Ar CH), 5.18 (t, J=6.2 Hz, 1H, 3-CH), 2.38 (m, 6H, SCH₃). ¹³C NMR (25° C., 101 MHz, CDCl₃) δ (ppm): 148.86 (N═C), 146.38 (N—C), 129.42, 128.48, 126.62, 123.86, 116.62 (Ar—C), 96.43 (N═C—CH), 16.56 (S—C).

### Examples for Lithiation of Ligands

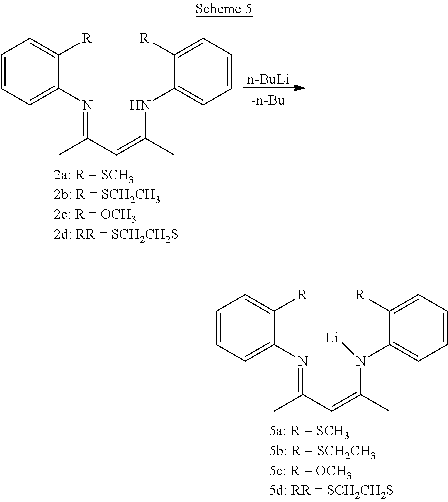

### Example 7

### Synthesis of Lithiated Ligand 5a (Scheme 5)

### Lithium N,N′-bis(2-methylthiophenyl)-1,3-diketiminate

2a (1.85 g, 5.40 mmol) was added to a dried Schlenk. Dry degassed pentane was transferred via cannula, and the pale yellow mixture cooled on ice. n-BuLi (3.4 mL, 1.6M in hexanes) was added dropwise to give a bright yellow mixture. After stirring for 3 hours at room temperature, the solid was filtered, washed with dry pentane and dried to give 5a as a bright yellow powder (1.21 g, 64%).

¹H NMR (400 MHz, C₆D₆) δ ppm: 1.90 (s, 6H, 2×NCCH₃), 1.99 (s, 6H, 2×SCH₃), 4.77 (s, 1H, β-CH), 6.82 (m, 2H, Ar p-CH), 6.90 (m, 2H, Ar o-CH), 7.08 (m, 2H, Ar m-CH), 7.10 (m, 2H, Ar m-CH). ¹³C NMR (101 MHz, C₆D₆) δ ppm: 16.2 (2×NCCH₃), 22.9 (2×SCH₃), 98.1 ((β-CH), 121.7, 121.9, 123.9, 124.0, (Ar CH), 127.0 (Ar CS), 130.4 (Ar i-C), 152.8 (C═N).

### Example 8

### Synthesis of Lithiated Ligand 5b (Scheme 5)

### Lithium N,N′-bis(2-ethylthiophenyl)-1,3-diketiminate

2b (3.0 g, 8.1 mmol) was added to a dried Schlenk. Dry degassed pentane was transferred via cannula, and the pale yellow mixture cooled on ice. n-BuLi (6.0 mL, 1.6M in hexanes) was added dropwise to give a bright red mixture. After stirring for 3 hours at room temperature, the resulting solid was filtered, washed with dry pentane and dried to give 5b as an orange powder (1.67 g, 55%).

¹H NMR (400 MHz, C₆D₆) δ ppm: 1.00 (t, 6H, J=7.3 Hz, CH₂CH₃), 1.86 (s, 6H, NCCH₃), 2.43 (br s, 4H, 2×CH₂), 4.63 (s, 1H, β-CH), 6.37 (br s, 1H, Ar o-CH to N), 6.68 (br s, 1H, Ar o-CH to N), 6.92 (m, 2H, Ar p-CH to N), 7.22 (br s, 4H, Ar m-CH to N). ¹³C NMR (101 MHz, C₆D₆) δ ppm: 14.15, 22.97, 27.77, 122.52, 125.18, 153.22. Not all signals were apparent.

### Example 9

### Synthesis of Lithiated Ligand 5c (Scheme 5)

### Lithium N,N′-bis(2-methoxyphenyl)-1,3-diketiminate

2c (1.50 g) was added to a dried Schlenk. Dry degassed pentane was transferred via cannula, and the pale yellow mixture cooled on ice. n-BuLi (3.4 ml, 1.6M in hexanes) was added dropwise to give a bright yellow mixture. After stirring for 3 hours at room temperature, the solid was filtered, washed with dry pentane and dried to give 5c as a bright yellow powder (1.09 g).

1H NMR (400 MHz, C₆D₆) δ ppm: 1.97 (s, 6H, NCCH₃), 3.07 (s, 6H, OCH₃), 4.81 (s, 1H, β-CH), 6.39 (d, J=8.0 Hz, 2H, Ar o-H to O), 6.77 (td, J=7.9, 1.6 Hz, 2H, Ar p-H to N), 6.86 (td, J=7.6, 1.1 Hz, 2H, Ar m-H to N), 6.95 (dd, J=7.7, 1.3 Hz, 2H, Ar o-H to N).

### Example 10

### Synthesis of Lithiated Ligand 5d (Scheme 5)

To 356 mg of 2d (1.05 mmol) in a 100 mL schlenk flask was added 10 mL of dry pentane under nitrogen at −98° C. While stirring, a solution of 1.1 equivalent of 1.6 M n-BuLi in hexane (0.7 mL, 1.15 mmol) was added slowly dropwise, and instantly the solution changed from a bright yellow to a light yellow color. The reaction mixture was stirred at room temperature for 3 hours and the solvent was reduced under vacuum to a light yellow solid and washed with pentane to get complex 5d (341 mg, 0.945 mmol, 90%). The lithiated complex 5d was used as synthesised without further analysis.

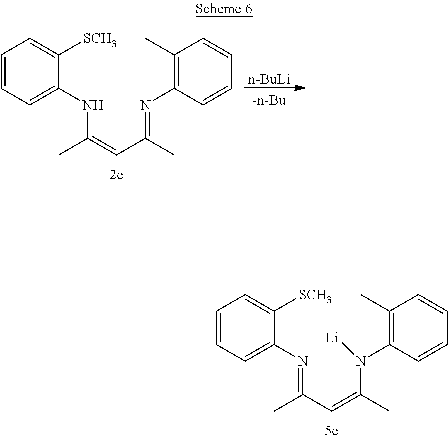

### Example 11

### Synthesis of Lithiated Ligand 5e (Scheme 6)

### Lithium N-(2,6-dimethylphenyl)-N′ (2-methoxyphenyl)-1,3-diketiminate

2e (3.05 g, 9.40 mmol) was added to a dried Schlenk. Dry degassed pentane was transferred via cannula, and the pale yellow mixture cooled on ice. n-BuLi (6.4 mL, 1.6M in hexanes) was added dropwise to give a bright yellow mixture. After stirring for 3 hours at room temperature, the solvent was removed to give 5e as a bright yellow powder (3.02 g, 97%) as a mixture of isomers.

¹H NMR (400 MHz, C₆D₆) δ ppm: 1.70 (s, 3H, isomer CH₃), 1.72 (s, 3H, isomer CH₃), 1.74 (s, 3H, isomer CH₃), 2.03 (s, 3H, SCH₃), 2.22 (s, 6H, 2×CH₃), 4.78 (s, 1H, β-CH), 6.57 (m, 1H, Ar CH), 6.75 (m, 1H, Ar CH), 6.84 (m, 1H, Ar CH), 6.95 (m, 2H, Ar CH) 7.10 (m, 2H, Ar CH).

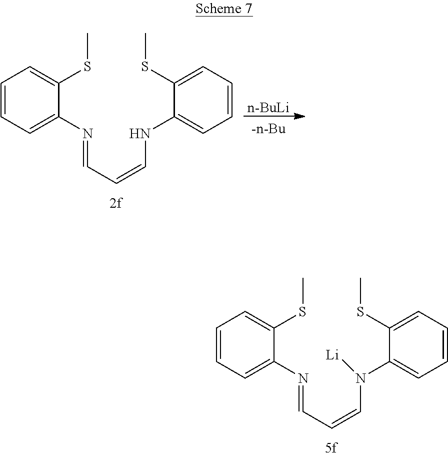

### Example 12

### Synthesis of Lithiated Ligand 5f (Scheme 7)

2f (1.0 g, 3.2 mmol) was added to a dried Schlenk flask. Dry degassed pentane was transferred via cannula, and the pale brown mixture was cooled on ice. n-BuLi (2.2 mL, 1.6M in hexanes) was added dropwise. After stirring for 3 hours at room temperature, the resulting solid was filtered, washed with dry pentane and dried to give 5f as a brown powder (0.7 g, 70%).

¹H NMR (400 MHz, C₆D₆) δ ppm: 7.90 (d, J=6.3, 2H, α-CH), 7.26 (dd, J=7.7, 1.5, 2H, Ar m-CH to N), 7.11 (ddd, J=8.1, 7.1, 1.5, 2H, Ar m-CH to N), 7.04 (dd, J=8.1, 1.5, 2H, Ar o-CH to N), 6.83 (ddd, J=7.7, 7.1, 1.5, 2H, Ar p-CH to N), 5.06 (t, J=6.3, 1 H, β-CH), 1.87 (s, 6H, SCH₃). ¹³C NMR (101 MHz, C₆D₆) δ ppm: 154.5 (α-CH), 154.4 (N—C_{Ar}), 131.70 (Ar m-CH to N), 129.41 (Ar m-CH to N), 128.30 (C—SCH₃), 122.31 (Ar p-CH to N), 117.21 (Ar o-CH to N), 96.00 (α-CH), 17.72 (SCH₃).

### Examples for Metal Complexes

It is understood that generally at some point, the donor ligand D dissociates in (ref. structure II) solution to form the active catalytic species, although at some point re-association cannot be ruled out. Some of the compounds (ref. Example 14, 16, 17) are isolated after synthesis as a mixture of the complex with the donor ligand D and the complex where D has been lost. These mixtures were used without further separation in the dehydrogenation experiments.

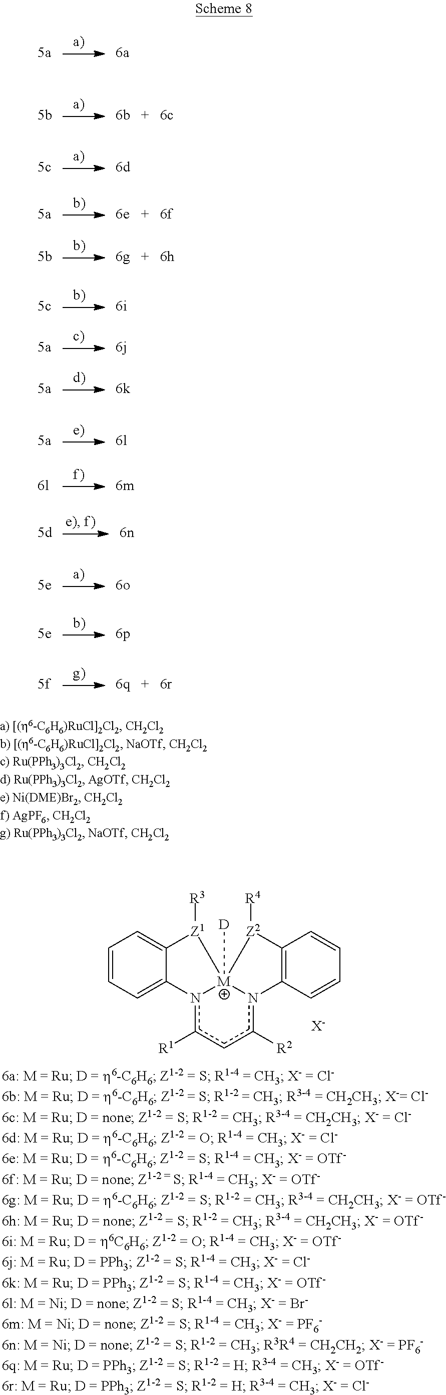

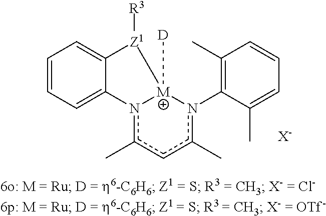

### Example 13

### Synthesis of Ruthenium Complex 6a (Scheme 8)

5a (0.50 g, 1.44 mmol) and [(η⁶-C₆H₆)RuCl]₂Cl₂ (0.36 g, 0.72 mmol) were added to a dry Schlenk. Dry degassed dichloromethane (10 mL) was transferred via cannula to give a dark red/brown solution which was stirred for 18 hours under N₂ at room temperature. The resulting dark red solution was filtered through Celite, washed with dry dichloromethane and the solvent removed in vaccuo. The residue was washed with dry pentane, which was decanted and the solid dried to give 6a as a dark red powder (0.32 g, 41%). Crystals suitable for x-ray were grown by slow diffusion of dichloromethane into a pentane solution of 6a.

¹H NMR (400 MHz, CD₂Cl₂) δ ppm: 1.62 (s, 6H, NCCH₃), 2.48 (s, 6H, SCH₃), 4.54 (s, 1H, β-CH), 4.70 (s, 6H, C₆H₆), 7.20 (m, 6H, Ar—H), 7.68 (m, 2H, Ar—H). ¹³C NMR (101 MHz, CD₂Cl₂) δ ppm: 14.3 (CCH₃), 23.9 (SCH₃), 86.0 (C₆H₆), 96.0 (β-CH), 123.1, 124.9, 125.3, 126.7 (Ar CH), 143.6 (Ar CS), 156.8 (Ar i-C), 161.7 (C═N). Anal. Found [Calc.] C: 54.15 [53.99], H: 4.94 [4.89], N: 5.25 [5.03].

### Example 14

### Synthesis of Ruthenium Complex 6b (Scheme 8)

5b (0.40 g, 1.06 mmol) and [(η⁶-C₆H₆)RuCl]₂Cl₂ (0.26 g, 0.53 mmol) were added to a dry Schlenk. Dry degassed dichloromethane (10 mL) was transferred via cannula to give a dark red/brown solution which was stirred for 18 hours under N₂ at room temperature. The resulting dark red solution was filtered through Celite, washed with dry dichloromethane and the solvent removed in vacuo. The residue was washed with dry pentane, which was decanted and the solid dried to give predominantly 6c with trace 6b as a dark red powder (0.18 g, 34%). ¹H NMR (Signals for; 400 MHz, CD₂Cl₂) 6 ppm: 1.21 (t, 3H, J=7.4 Hz, SCH₂CH₃), 1.43 (t, 3H, J=7.3 Hz, SCH₂CH₃), 1.89 (s, 6H, NCCH₃), 2.81 (dd, 2H, J=7.4 Hz, 14.7 Hz, SCH₂), 3.03 (m, 2H, SCH₂), 6.28 (s, 1H, β-CH), 6.91-7.68 (m, 8H, Ar CH). ¹³C NMR (101 MHz, CD₂Cl₂) δ ppm: 14.3, 21.1, 23.9, 24.9, 26.8, 86.1, 87.2, 97.9, 123.6, 123.9, 124.6, 125.4, 126.2, 128.2, 128.6, 144.9, 160.6. ESI-MS (25° C., CH₂Cl₂), (m/z) positive mode 549.41 [6b, 30%], 471.39 [6c, 70%].

### Example 15

### Synthesis of Ruthenium Complex 6d (Scheme 8)

5c (0.40 g) and [(η⁶-C₆H₆)RuCl]₂Cl₂ (0.32 g) were added to a dry Schlenk. Dry degassed dichloromethane (10 mL) was transferred via cannula to give a dark red/brown solution which was stirred for 18 hours under N₂ at room temperature. The resulting dark red solution was filtered through Celite, washed with dry DCM and the solvent removed in vaccuo. The residue was washed with dry pentane, which was decanted and the solid dried to give complex 6d as a dark purple powder (0.52 g).

¹H NMR (400 MHz, CD₂Cl₂) δ ppm: 1.62 (s, 6H, NCCH₃), 4.00 (s, 6H, OCH₃), 4.45 (s, 1H, (β-CH), 4.59 (s, 6H, C₆H₆), 7.02 (m, 4H, Ar CH), 7.19 (m, 2H, Ar CH), 7.91 (m, 2H, Ar CH).

### Example 16

### Synthesis of Ru Complex 6e (Scheme 8)

5a (0.47 g, 1.33 mmol), [(η⁶-C₆H₆)RuCl]₂Cl₂ (0.34 g, 0.67 mmol) and sodium triflate (0.26 g, 1.50 mmol) were added to a dry Schlenk. Dry degassed dichloromethane (10 mL) was transferred via cannula to give a brown solution which was stirred for 18 hours under N₂ at room temperature. The resulting dark red solution was filtered through Celite, washed with dry dichloromethane and the solvent removed in vaccuo. The residue was washed with dry pentane, which was decanted and the solid dried to give the product as a dark red powder (0.71 g, 80%). Crystals suitable for x-ray were grown by slow diffusion (THF). The NMR for this complex shows two species, one containing the coordinated benzene ring (6e), and one where benzene has been lost (6f). Percentage yield based on complex 6e. Crystals suitable for x-ray were grown by slow diffusion of dichloromethane into a pentane solution of 6e.

6e: ¹H NMR (400 MHz, CD₂Cl₂) δ ppm: 2.10 (s, 6H, NCCH₃), 2.44 (s, 6H, SCH₃), 6.29 (s, 1H, β-CH), 5.24 (s, 6H, C₆H₆), 7.01 (m, 2H, Ar—H), 7.10 (m, 6H, Ar—H).

6f: ¹H NMR (400 MHz, CD₂Cl₂) δ ppm: 1.79 (s, 6H, NCCH₃), 2.26 (s, 6H, SCH₃), 5.87 (s, 1H, β-CH), 7.40 (m, 8H, Ar—H). ¹³C NMR (101 MHz, CD₂Cl₂) δ ppm: 14.4, 14.5, 14.8, 20.4, 23.2, 83.5, 86.7, 97.1, 104.2, 119.3, 122.5, 124.0, 124.2, 124.3, 124.8, 125.2, 127.0, 127.9, 128.3, 130.2, 130.6, 132.9, 133.2, 143.1, 156.1, 159.3, 160.6, 164.2. ¹⁹F NMR (376 MHz, CD₂Cl₂) δ ppm: −78.8 (OTf). Anal. Found [Calc.] C: 47.99 [46.62], H: 4.11 [4.06], N: 4.61 [4.18]. ESI-MS (25° C., CH₂Cl₂), (m/z) positive mode 443.34 [6f, 100%], 521.33 [6e, 30%].

### Example 17

### Synthesis of Ru Complex 6g (Scheme 8)

5b (0.40 g, 1.06 mmol), [(η⁶-C₆H₆)RuCl]₂Cl₂ (0.26 g, 0.53 mmol) and sodium triflate (0.20 g, 1.16 mmol) were added to a dry Schlenk. Dry degassed dichloromethane (10 mL) was transferred via cannula to give a brown solution which was stirred for 18 hours under N₂ at room temperature. The resulting dark red solution was filtered through Celite, washed with dry dichloromethane and the solvent removed in vaccuo. The residue was washed with dry pentane, which was decanted and the solid dried to give predominantly complex 6h, where the benzene ligand has been lost, as a dark red crystalline solid (0.33 g, 50%) with some presence of the title complex 6g (10-40% varying). ¹H NMR (Signals for 6h; 400 MHz, CD₂Cl₂) δ 1.21 (t, 3H, J=7.4 Hz, CH₂CH₃), 1.39 (m, 3H, CH₂CH₃), 1.89 (s, 6H, NCCH₃), 2.79 (m, 2H, CH₂), 3.03 (m, 2H, CH₂), 6.00 (s, 1H, β-CH), 6.91-7.45 (m, 8H, Ar—H). ¹³C NMR (101 MHz, CD₂Cl₂) δ ppm: 14.3, 21.1, 23.9, 26.8, 84.0, 87.3, 98.0, 123.9, 124.6, 126.2, 128.6, 128.8, 144.9, 160.6. ¹⁹F NMR (376 MHz, CD₂Cl₂) δ ppm: −78.8. ESI-MS (25° C., CH₂Cl₂), (m/z) positive mode 471.39 [parent, 60%].

### Example 18

### Synthesis of Ru Complex 6i (Scheme 8)

(0.35 g, 0.67 mmol) 5c and sodium triflate (0.138 g, 0.80 mmol) were added to a dry Schlenk. Dry degassed dichloromethane (10 ml) was transferred via cannula to give a brown solution which was stirred for 18 hours under N₂ at room temperature. The resulting dark red solution was filtered through Celite, washed with dry dichloromethane and the solvent removed in vacuo. The residue was washed with dry pentane, which was decanted and the solid dried to give 6i as a red/orange powder (0.30 g, 70%).

¹H NMR (400 MHz, CD₂Cl₂) δ ppm: 2.20 (s, 6H, NCCH₃), 4.00 (s, 6H, OCH₃), 5.15 (s, 6H, C₆H₆), 6.41 (s, 1H, β-CH), 7.21 (m, 4H, Ar—H), 7.31 (m, 2H, Ar—H) 7.49 (m, 2H, Ar—H).

### Example 19

### Synthesis of Ru Complex 6j (Scheme 8)

To 5a (156 mg, 0.438 mmol) was added a solution of complex [Ru(PPh₃)₃Cl₂] (420 mg, 0.438 mmol) in dry dichloromethane (10 mL) under nitrogen at room temperature, and instantly the solution changed to a purple color. The reaction mixture was stirred for 14 h under nitrogen at room temperature. Afterward the purple solution was filtered through a frit containing at least 1 cm pad of Celite. The Celite was washed with dichloromethane until the filtrate was colorless. The volume of the filtrate was reduced, under vacuum, to 2 mL, and 25 mL of n-pentane was added to precipitate a purple-colored microcrystalline powder. The solution was decanted from the solid and dried under vacuum for several hours. The product was stable in air as a purple solid complex 6j (yield=304 mg, 0.411 mmol, 94%).

¹H NMR (25° C., 300 MHz, CDCl₃) δ (ppm): 7.31 (d, J=9.5 Hz, 6H, PPh₃ o-H), 7.23 (t, J=3.5 Hz, 6H, PPh₃ m-H), 7.17 (d, J=6.9 Hz, 3H, PPh₃ p-H), 6.97 (m, 4H, Ar—CH), 6.80 (m, 2H, Ar—CH), 4.56 (s, 1H, (β-CH), 2.80 (s, 6H, SCH₃), 1.81 (s, 6H, α-CH₃). ¹³C NMR (25° C., 101 MHz, CDCl₃) δ (ppm): 158.88 (C═N), 154.35 (C—N), 133.56, 129.64, 128.44, 127.51, 126.36, 124.08, 121.71 (Ar—C), 109.99 (N═C—CH), 25.26 (SCH₃), 22.76 (N═CCH₃). ³¹P NMR (25° C., 121 MHz, CDCl₃) δ (ppm): 58.67 (s, PPh₃). TOF MS-ES (25° C., dichloromethane), positive mode (m/z): exp. Mass for C37H36N2PS2ClRu [Parent [M]+=740.0821 (100%), calculated [M]+=740.0790 (100%)]. Elemental analysis: Found [Calculated] for C₃+H₃₆ClN₂PRuS₂. 5 CH₂Cl₂; C: 45.96 [45.59], H: 4.04 [4.11], N: 2.52 [2.59].

### Example 20

### Synthesis of Ru Complex 6k (Scheme 8)

To 5a (150 mg, 0.421 mmol) and silver triflate (108 mg, 0.421 mmol) was added a solution of complex [Ru(PPh₃)₃Cl₂] (403 mg, 0.421 mmol) in dry 10 mL CH₂Cl₂ under nitrogen at room temperature, and instantly the solution changed to a purple color. The reaction mixture was stirred for 14 h under nitrogen at room temperature. Afterward the purple solution was filtered through a frit containing at least 1 cm pad of Celite. The Celite was washed with dichloromethane until the filtrate was colorless. The volume of the filtrate was reduced, under vacuum, to 2 mL, and 25 mL of n-pentane was added to precipitate a purple-colored microcrystalline powder. The solution was decanted from the solid, dried under vacuum for several hours and kept under glove box. The yield of the purple complex 6k was 95% (340 mg, 0.398 mmol). 1H NMR (400 MHz, CD₂Cl₂) δ (ppm): 7.35 (dd, J=7.7, 1.5, 2H, Ar m-CH to N), 7.31-7.14 (m, 15H, PPh₃), 7.03 (ddd, J=8.4, 7.0, 1.5, 2H, Ar m-CH to N), 6.91 (dd, J=8.4, 1.5, 2H, Ar o-CH to N), 6.91-6.81 (m, 2H, Ar p-CH to N), 4.62 (s, 1H, β-CH), 2.78 (s, 6H, SCH₃), 1.81 (s, 6H, α-CH₃). ¹³C NMR (101 MHz, CD₂Cl₂) δ (ppm): 159.53 (C═N), 154.97 (N—C_{Ar}), 136.41 (d, ¹J_{PC}=41.2, PPh₃ Cᵢₚₛₒ), 134.58 (C—SCH₃), 134.13 (d, J_{PC}=8.9, PPh₃ C_{ortho/meta}), 129.55 (d, ⁴J_{PC}=2.2, PPh₃ Cₚₐᵣₐ), 129.38 (Ar m-CH to N), 128.14 (d, J_{PC}=8.9, PPh₃ C_{ortho/meta}) 126.80 (Ar m-CH to N), 124.32 (Ar o-CH to N), 122.12 (Ar p-CH to N) 113.97 (β-CH), 25.56 (SCH₃), 22.92 (N═CCH₃). ¹P NMR (121 MHz, CD₂Cl₂) δ (ppm): 58.42 (s, PPh₃). ¹⁹F NMR (282 MHz, CD₂Cl₂) 6 (ppm): −78.84 (s, —O₃SCF₃).

### Example 21

### Synthesis of Ni Complex 6m (Scheme 6)

Intermediate 6l CAS 1198159-01-1 has been described by Pfirrmann et al (Z. Anorg. Allg. Chem. 2009, 635, 312-316). To 5a (250 mg, 0.717 mmol) was added a suspensions of orange complex [Ni(DME)Br₂] (221.5 mg, 0.717 mmol) in a dry 10 mL CH₂Cl₂ under nitrogen at room temperature, and after 10 minutes the solution changed to a dark green color. The reaction mixture was stirred for 14 h under nitrogen at room temperature. Afterward the green solution was filtered through a frit containing at least 1 cm pad of Celite. The Celite was washed with CH₂Cl₂ until the filtrate was colorless. The volume of the filtrate was reduced, under vacuum, to 2 mL, and 25 mL of n-pentane was added to precipitate a green colored microcrystalline powder. The solution was decanted from the solid and dried under vacuum for several hours. The product was treat as unstable in air as a green solid complex 6l (yield=201 mg, 0.416 mmol, 58%). Without any further analysis of above product, silver hexafluorophosphate (105 mg, 0.416 mmol) was added in to the dichloromethane (10 mL) solution of 6l (201 mg, 0.416 mmol) and the reaction mixture was stirred for 14 h under nitrogen at room temperature. Afterward the dark green solution was filtered through a frit containing at least 1 cm pad of Celite. The Celite was washed with CH₂Cl₂ until the filtrate was colorless. The volume of the filtrate was reduced, under vacuum to precipitate a green colored microcrystalline powder of 6m (yield=160 mg, 0.333 mmol, 80%). The product was confirmed by HRMS due to its paramagnetic behaviour.

TOF MS-ES (25° C., CH₂Cl₂), positive mode (m/z): Exp. Mass for [C₁₉H₂₁F₆N₂NiPS₂]: [Parent [M]+=544.1911 (100%), calculated [M]+=544.0141 (100%)].

### Example 22

### Synthesis of Ni Complex 6n (Scheme 8)

To 5d (356 mg, 1.05 mmol) was added a suspension of orange complex [Ni(DME)Br₂] (324 mg, 1.05 mmol) and AgPF₆ (265.5 mg, 1.05 mmol) in a dry 10 mL dichloromethane under nitrogen at room temperature, and after 10 minutes the solution changed to a dark brown color. The reaction mixture was stirred for 14 h under nitrogen at room temperature. Afterward the brown solution was filtered through a frit containing at least 1 cm pad of Celite. The Celite was washed with dichloromethane until the filtrate was colorless. The volume of the filtrate was reduced under vacuum to precipitate a brown colored microcrystalline powder. The solution was decanted from the solid and dried under vacuum for several hours. The product was treat as unstable in air as a brown solid complex 6n (yield=251 mg, 0.462 mmol, 44%). The product was confirmed by HRMS due to its paramagnetic behaviour.

TOF MS-ES (25° C., dichloromethane), positive mode (m/z): Exp. Mass for [C₁₉H₁₉F₆N₂NiPS₂]: [Parent [M]+=543.1212 (100%), calculated [M]+=543.0132 (100%)].

### Example 23

### Synthesis of Ru Complex 6o (Scheme 8)

5e (0.40 g, 1.21 mmol) and [(η⁶-C₆H₆)RuCl]₂Cl₂ (0.30 g, 0.61 mmol) were added to a dry Schlenk. Dry degassed dichloromethane (10 mL) was transferred via cannula to give a dark red/brown solution which was stirred for 18 hours under N₂ at room temperature. The resulting dark red solution was filtered through Celite, washed with dry dichloromethane and the solvent removed in vaccuo. The residue was washed with dry pentane, which was decanted and the solid dried to give 6o as a pale beige/brown powder (0.26 g, 41%) as a mixture of isomers.

¹H NMR (400 MHz, CD₂Cl₂) δ ppm: 1.53 (s, 3H, isomer CH₃), 1.63 (s, 3H, isomer CH₃), 2.23 (s, 3H, phenyl CH₃), 2.48 (s, 3H, isomer CH₃), 2.55 (s, 3H, phenyl CH₃), 4.56 (s, 6H, C₆H₆), 4.73 (s, 1H, β-CH), 7.02 (m, 2H, Ar—H), 7.18 (m, 4H, Ar—H) 7.61 (m, 1H, Ar—H).

### Example 24

### Synthesis of Ru Complex 6p (Scheme 8)

5e (0.40 g, 1.21 mmol), [(η⁶-C₆H₆)RuCl]₂Cl₂ (0.30 g, 0.61 mmol) and sodium triflate (0.23 g, 1.33 mmol) were added to a dry Schlenk. Dry degassed dichloromethane (10 mL) was transferred via cannula to give a purple solution which was stirred for 18 hours under N₂ at room temperature. The resulting dark brown solution was filtered through Celite, washed with dry dichloromethane and the solvent removed in vaccuo. The residue was washed with dry pentane, which was decanted and the solid dried to give 6p as a golden powder (0.40 g, 51%) as a mixture of isomers.

¹H NMR (400 MHz, CD₂Cl₂) δ ppm: 1.67 (s, 3H, isomer CH₃), 2.09 (s, 3H, isomer CH₃), 2.13 (s, 3H, isomer CH₃), 2.15 (s, 3H, isomer CH₃), 2.22 (s, 6H, phenyl 2×CH₃), 2.53 (s, 3H, isomer CH₃), 5.20 (s, 6H, O₆H₆), 6.51 (s, 1H, (β-CH), 7.02 (m, 1H, Ar—H), 7.31 (m, 1H, Ar—H) 7.40 (m, 2H, Ar—H), 7.50 (m, 3H, Ar—H). ¹³C NMR (101 MHz, CD₂Cl₂) δ ppm: 14.1, 15.1, 18.6, 19.0, 19.2, 20.6, 23.4, 23.8 (CH₃), 84.1 (C6H6), 105.3 ((β-CH), 124.6, 124.7, 125.5, 127.9, 128.2, 128.6, 129.5, 129.6, 130.1, 132.7 (Ar—C), 164.1, 164.7.

### Example 25

### Synthesis of Ru Complex 6q (Scheme 8)

5f (52 mg, 0.15 mmol), [Ru(PPh₃)₃Cl₂] (144 mg, 0.15 mmol) and sodium triflate (28 mg, 0.16 mmol) were dissolved in dry CH₂Cl₂ (10 mL) under nitrogen and left to stir for 24 h at room temperature. Upon dissolution the color instantly changed from green to purple. The solution was filtered through a 1 cm celite pad and washed with CH₂Cl₂ until the filtrate was colorless. The volume of the filtrate was reduced to 2 mL under vaccum and dry n-pentane (25 mL) was added to precipitate complex 6q as purple-colored powder. The solid was filtered, dried under vacuum and kept in glove box. Yield 80 mg (63%). A small quantity of compound 6r crystallized as side product (not quantified; structure was identified by X-ray diffraction analysis).

¹H NMR (400 MHz, CD₂Cl₂)⁶ (ppm): 7.84 (d, J=6.9, 2H, α-CH), 7.43-7.28 (m, 4H, Ar), 7.18-6.98 (m, 17H, Ar+PPh₃), 6.94-6.81 (m, 2H, Ar p-CH to N), 5.08 (t, J=6.9, 1H, (β-CH), 2.88 (s, 6H, SCH₃). ¹³C NMR (101 MHz, CD₂Cl₂) δ (ppm): 153.62 (N—C_{Ar}), 144.24 (α-CH), 134.23 (d, J_{PC}=9.1, PPh₃ C_{ortho/meta}), 133.13 (d, ¹J_{PC}=42.7, PPh₃ Cᵢₚₛₒ), 131.13 (Ar m-CH to N), 130.73 (C—SCH₃), 129.68 (br, PPh₃ Cₚₐᵣₐ) 1, 129.16 (Ar m-CH to N), 127.61 (d, J_{PC}=9.1, PPh₃ C_{ortho/meta}), 122.78 (Ar p-CH to N), 116.05 (Ar o-CH to N), 98.06 ((β-CH), 23.19 (SCH₃). ¹P NMR (121 MHz, CD₂Cl₂) δ (ppm): 55.14 (s, PPh₃).

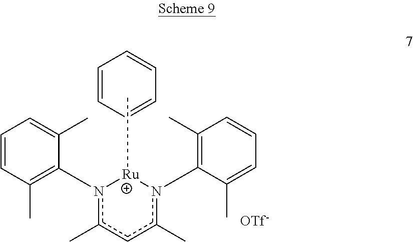

### Comparative Example 1

### Synthesis of Ru Complex 7 (Scheme 9)

### (η⁶-Benzene)-ruthenium(II)-κ²N,N′—N,N′-bis(2,6-dimethylphenyl)-1,3-diketiminato trifluoromethanesulfonate

The synthesis and analysis of this catalyst has been described previously by Phillips et al (Organometallics 2007, 26, 1120-1122).

### Examples for Dehydrogenation Reactions

### Example 26

### Dehydrogenation of Ammonia Borane in THF with Catalyst 6k at 42° C. (FIG. 1)

A 100 mL Parr 100 bar stainless steel pressure reactor, fitted with an inlet valve (Swagelok SS-ORM2), release valve (Swagelok SS-43GS4), thermocouple, rupture disc, stirrer shaft (Parr A1120HC5), and a 0-100 bar pressure gauge (Impress Sensors & Systems) connected to a Parr 4842 controller unit, was used for the experiment. To avoid contamination of the reactor interior by traces of catalyst, a base/acid cleaned glass liner was used for the experiment. Stirrer and thermocouple probe were sanded prior to each run. The reaction was carried out without stirring as homogeneous mixing was ensured through internal gas evolution. H₂ equivalents respectively to AB substrate were calculated from the recorded pressure data assuming ideal gas behaviour, assuming a total reactor volume (including head space) of 84 mL.

The Parr pressure reactor was flushed with nitrogen and preheated to 42° C. using an oil bath prior to the start of the experiment. A glass liner was filled with 0.5 g (16 mmol) of ammonia borane and 0.5 mol % (0.08 mmol, 69 mg) of 6k under a stream of N₂, inserted into the reactor, and the reactor was sealed. 5 mL of dried/N₂ saturated THF were added through the sampling valve via a gas-tight syringe and the valve was closed.

### Comparative Example 2

### Dehydrogenation of Ammonia Borane in THF with Catalyst 7 at 42° C. (FIG. 1)

Procedure as in Example 26. Ammonia borane: 1.0 g (32 mmol); catalyst: 0.5 mol %, 0.16 mmol, 102 mg; THF: 10 mL.

### Comparative Example 3

### Dehydrogenation of Ammonia Borane in THF without Catalyst at 42° C. (FIG. 1)

Procedure as in Example 26. Ammonia borane: 1.0 g (32 mmol); THF: 10 mL.

### Example 27

### Dehydrogenation of Ammonia Borane in BmimBF₄ with Catalyst 6e at 74° C. (FIG. 2)

Following the procedure of Ex. 26, the Parr pressure reactor was preheated to 74° C. A glass liner was filled with 0.5 mol % (0.06 mmol, 42 mg) of 6e under a stream of N₂, inserted into the reactor, and the reactor was sealed. A solution of ammonia borane (0.39 g, 12.7 mmol) in dry 1-butyl-1-methylimidazolium tetrafluoroborate (2.9 mL) was added through the sampling valve via a gas-tight syringe and the valve was closed.

### Example 28

### Dehydrogenation of Ammonia Borane in BmimCl with Catalyst 6e at 74° C. (FIG. 2)

Following the procedure of Ex. 26, the Parr pressure reactor was preheated to 74° C. A glass liner was filled with 0.5 mol % (0.06 mmol, 42 mg) 6e, ammonia borane (0.39 g, 12.7 mmol), and dry 1-butyl-1-methylimidazolium chloride (4 g) under a stream of N₂, inserted into the reactor, and the reactor was sealed.

### Comparative Examples 4-5

### Dehydrogenation of Ammonia Borane in BmimCl or BmimBF₄ without Catalyst at 74° C. (FIG. 2)

Following the procedure of Exp. 27 (Comp. Ex. 4) or Exp. 28 (Comp. Ex. 5) without 6e.

### Example 29

### Dehydrogenation of DMAB in THF with 6e at Room Temperature (FIG. 3)

Following the procedure of Ex. 26, a glass liner was filled with DMAB (0.95 g, 16.2 mmol), under a stream of N₂, inserted into the reactor, and the reactor was sealed. A solution of 0.5 mol % (0.08 mmol, 54 mg) 6e in 5 mL of dried/N₂ saturated THF was added through the sampling valve via a gas-tight syringe and the valve was closed.

### Example 30

### Dehydrogenation of DMAB in THF with 6k at Room Temperature (FIG. 3)

Following the procedure of Ex. 26, a glass liner was filled with DMAB (0.95 g, 16.2 mmol) and 0.5 mol % (0.08 mmol, 69 mg) 6k under a stream of N₂, inserted into the reactor, and the reactor was sealed. 5 mL of dried/N₂ saturated THF was added through the sampling valve via a gas-tight syringe and the valve was closed.

### Comparative Example 6

### Dehydrogenation of DMAB in THF with Catalyst 7 at Room Temperature (FIG. 3)

Procedure as in Example 29. DMAB: 0.95 g (16.2 mmol); catalyst: 0.5 mol %, 0.08 mmol, 51 mg; THF: 5 mL.

### Comparative Example 7

### Dehydrogenation of DMAB in THF without Catalyst at 42° C. (FIG. 7)

Procedure as in Comparative Example 6 without catalyst.

### Examples 31-34, Comparative Example 8

### Dehydrogenation of DMAB in THF at 42° C. (FIG. 4)

Following the procedure of Ex. 26.

| | Catalyst | | | |
|---|---|---|---|---|
| Exp. | | | | |
| 31 | 6k | 69 mg | 0.08 mmol | 0.5 mol % |
| 32 | 6e | 54 mg | 0.08 mmol | 0.5 mol % |
| 33* | 6j | 60 mg | 0.08 mmol | 0.5 mol % |
| 34^{#} | 6g | 57 mg | 0.08 mmol | 0.5 mol % |
| Comp. Exp. | | | | |
| 8 | 7 | 54 mg | 0.08 mmol | 0.5 mol % |

*catalyst added dissolved in THF
^{#}DMAB added dissolved in THF

### Example 35

### Solvent-Free Dehydrogenation of DMAB at 42° C. With Catalyst 6e (FIG. 5)

Following the procedure of Ex. 26. DMAB (51 mmol, 2.98 g) and 6e (0.13 mol %, 0.06 mmol, 44 mg were reacted.

### Comparative Example 9

### Solvent-Free Dehydrogenation of DMAB at 42° C. With Catalyst 7 (FIG. 5)

Following the procedure of Ex. 35. DMAB (51 mmol, 2.98 g) and 7 (0.13 mol %, 0.06 mmol, 40 mg) were reacted.

### Comparative Example 10

### Solvent-Free Dehydrogenation of DMAB at 42° C. Without Catalyst (FIG. 5)

Procedure as in Comparative Example 9 without catalyst.

### Example 36

### Dehydrogenation of DMAB in THF at Room Temperature with Catalyst 6e Under Non-Protective Atmosphere (FIG. 6)

Procedure as described in Ex. 29, but with standard THF and not under protective atmosphere.

### Comparative Example 11

### Dehydrogenation of DMAB in THF at Room Temperature without Catalyst Under Non-Protective Atmosphere (FIG. 6)

Procedure as described in Ex. 36, but without catalyst

### Example 37

### Dehydrogenation of DMAB in THF 42° C. With Catalyst 6e Under Addition of Further Aliquots of DMAB/THF Solution (FIGS. 7a/7b)

Procedure as described in Ex. 28. To 6e (0.5 mol %, 0.8 mmol, 54 mg) was added DMAB (0.95 g, 16 mmol) in THF (5 mL). Further aliquots of 1 mL of a total of 9.3 mL of DMAB (4.13 g) in THF (5 mL) were added.

| | Effective | |
|---|---|---|
| | DMAB conc. in | |
| Cycle | solution | Remark |
| 0 | 3.24M | Reaction started as normal |
| 1 | 1.26M | 1^{st} aliquot added etc. |
| 2 | 1.08M | |
| 3 | 0.94M | |
| 4 | 0.84M | |
| 5 | 0.75M | |
| 6 | 0.69M | |
| 7 | 0.63M | |
| 8 | 0.58M | |
| 9 | 0.54M | |
| 10 | 0.16M | |
| 11 | 0.82M | Addition of higher conc. Stock solution next |
| | | day |
| 12 | 0.74M | Rct. stirred |
| 13 | 0.67M | Rct. stirred, air purged (not inert) |

### Example 38

### Synthesis of Ligand 9 (Scheme 10)

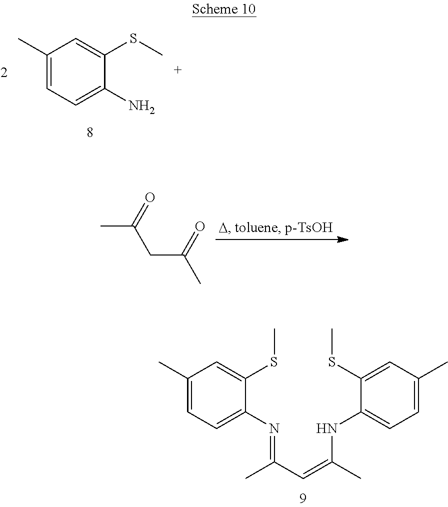

Acetylacetone (0.96 g, 9.59 mmol) and p-toluenesulfonic acid monohydrate (2.00 g, 10.5 mmol) were added to a 3-neck round-bottom flask with a Dean-Stark apparatus connected. Degassed toluene (150 mL) and 4-methyl-2-(methylthio)aniline 8 (2.88 g, 18.67 mmol) were added to give a green solution, and the mixture refluxed at 150° C. for 24 hours. The resulting yellow solution was cooled, and solvent removed. The resulting oil was taken up in dichloromethane (100 ml) and stirred with a solution of sodium carbonate (40 g in 100 ml H2O) for 30 minutes. The organic layer was separated and the aqueous layer extracted with dichloromethane (3×50 mL), the organic layers were combined, washed with brine, and dried over magnesium sulfate. The solvent was removed to give yellow oil. Recrystallization from methanol gave 9 as bright yellow powder (2.50 g, 70%). 1H NMR (400 MHz, CDCl3) δ ppm: 1.89 (s, 6H, NCCH3), 2.32, 2.35 (2 s, 6H each, —SCH3, Ar—CH3), 4.92 (s, 1H, β-CH), 6.8-7.0 (m, 6H, Ar—CH), 12.42 (br s, 1H, NH).

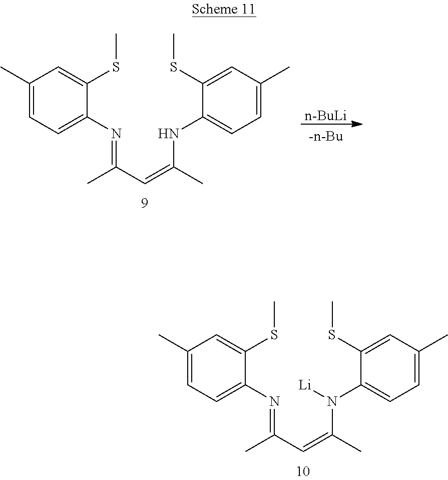

### Example 39

### Synthesis of Lithiated Ligand 10 (Scheme 11)

9 (1.00 g, 2.70 mmol) was added to a dried Schlenk. Dry degassed pentane was transferred via cannula, and the pale yellow mixture cooled on ice. n-BuLi (1.95 mL, 1.6M in hexanes) was added dropwise to give a bright yellow mixture. After stirring for 3 hours at room temperature, the solid precipitate was removed by filtration and the filtrate reduced in vacuum to give 10 as a bright yellow powder (0.28 g, 26%) which was reacted further without characterisation.

### Examples for Metal Complexes

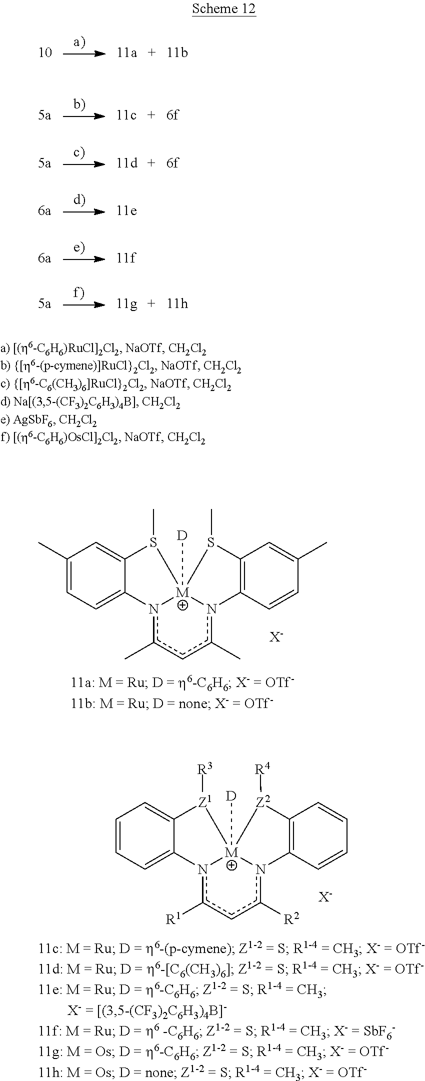

### Example 40

### Synthesis of Ruthenium Complex 11a (Scheme 12)

10 (0.25 g, 0.66 mmol), [(η⁶-C₆H₆)RuCl]₂Cl₂ (0.17 g, 0.33 mmol) and sodium triflate (0.126 g, 0.73 mmol) were added to a dry Schlenk. Dry degassed dichloromethane (10 mL) was transferred via cannula to give a brown solution which was stirred for 18 hours under N₂ at room temperature. The resulting dark red solution was filtered through Celite, washed with dry dichloromethane and the solvent removed in vaccuo. The residue was washed with dry pentane, which was decanted and the solid dried to give the product as a dark red powder (0.20 g, 43%). The NMR for this complex shows two species, one containing the coordinated benzene ring (11a), and one where benzene has been lost (11b). Percentage yield based on complex 11a. Each of the species occurs in different stereoisomers yielding a highly complex ¹H NMR spectrum.

¹H NMR (400 MHz, CD₂Cl₂) δ ppm: 2.05-2.56 (m, CH₃), 4.87-5.27 (m, C₆H₆), 5.95 (s, P—CH), 6.97-7.35 (m, Ar—H). ¹⁹F NMR (376 MHz, CD₂Cl₂) δ ppm: −78.7 (OTf).

### Example 41

### Synthesis of Ruthenium Complex 11c (Scheme 12)

5a (0.40 g, 1.19 mmol), {[η⁶-(C₆(CH₃)₆)]RuCl}₂Cl₂ (0.34 g, 0.57 mmol) and sodium triflate (0.23 g, 1.32 mmol) were added to a dry Schlenk. Dry degassed dichloromethane (10 mL) was transferred via cannula to give a brown solution which was stirred for 18 hours under N₂ at room temperature. The resulting dark red solution was filtered through Celite, washed with dry dichloromethane and the solvent removed in vaccuo. The residue was washed with dry pentane, which was decanted and the solid dried to give the product as a dark red powder (0.50 g, 64%). The NMR for this complex shows two species, one containing the coordinated p-cymene (11c), and one where p-cymene has been lost (6f). Percentage yield based on complex 11c.

¹H NMR (400 MHz, CD₂Cl₂) δ ppm: 1.17-1.22 (m, 1H, p-cymene-CH), 1.89 (s, 3H, p-cymene-C H₃), 2.09 & 2.11 (2 s, 3H, SCH₃), 2.20 (s, 6H, NCCH₃), 2.36 (s, 3H, SCH₃), 2.55 & 2.56 (s, 6H, p-cymene-CH₃), 4.52-4.99 (m, 4H, p-cymene-Ar—H), 6.27 & 6.29 (2 s, 1H, (β-CH), 7.09-7.11 (m, 2H, ANN). ¹⁹F NMR (376 MHz, CD₂Cl₂) δ ppm: −78.8 (OTf).

### Example 42

### Synthesis of Ruthenium Complex 11d (Scheme 12)

5a (0.21 g, 0.56 mmol), {[η⁶-(p-cymene)]RuCl}₂Cl₂ (0.20 g, 0.30 mmol) and sodium triflate (0.11 g, 0.66 mmol) were added to a dry Schlenk. Dry degassed dichloromethane (10 mL) was transferred via cannula to give a brown solution which was stirred for 18 hours under N₂ at room temperature. The resulting dark red solution was filtered through Celite, washed with dry dichloromethane and the solvent removed in vaccuo. The residue was washed with dry pentane, which was decanted and the solid dried to give the product as a dark red powder (0.50 g, 64%). The NMR for this complex shows two species, one containing the coordinated hexamethylbenzene ring (11c), and one where hexamethylbenzene has been lost (6f). Percentage yield based on complex 11c. Each of the species occurs in different stereoismoers yielding a highly complex ¹H NMR spectrum.

### Example 43

### Synthesis of Ruthenium Complex 11e (Scheme 12)

A solution of 6a (0.20 g, 0.29 mmol) in dry degassed dichloromethane (10 mL) was added to a solution of Na[{3,5-(CF₃)₂C₆H₃}₄B] (0.36 g, 0.41 mmol) in dry degassed dichloromethane (10 mL) in a Schlenk. The resulting dark red brown solution which was stirred for 18 hours under N₂ at room temperature. The solution was filtered through Celite, washed with dry dichloromethane and the solvent removed in vaccuo. The residue was washed with dry pentane, which was decanted and the solid dried to give 11e as a green powder (0.35 g, 94%).

¹H NMR (400 MHz, CD₂Cl₂) δ ppm: 2.12 (s, 6H, NCCH₃), 2.22-2.54 (m (different stereoisomers), 6H, SCH₃), 5.20 (s, 6H, C₆H₆), 6.29 (s, 1H, (—CH), 7.30-7.48 (m, 8H, Ar—H), 7.59 & 7.76 (2 s br, 12H, BARF—H). ¹⁹F NMR (282 MHz, CD₂Cl₂) δ ppm: −62.77 (BAr^{F}₄).

### Example 44

### Synthesis of Ruthenium Complex 11f (Scheme 12)

6a (0.20 g, 0.29 mmol) and silver hexafluoroantimonate (0.14 g, 0.41 mmol) were added to a dry Schlenk. Dry degassed dichloromethane (10 mL) was transferred via cannula to give a dark red brown solution which was stirred for 18 hours under N₂ at room temperature and under protection from light. The solution was filtered through Celite, washed with dry dichloromethane and the solvent removed in vaccuo. The residue was washed with dry pentane, which was decanted and the solid dried to give 11f as a green powder (0.15 g, 68%).

¹H NMR (400 MHz, CD₂Cl₂) δ ppm: 2.21 & 2.22 (2 s (different stereoisomers), 6H, NCCH₃), 2.55 (s, 6H, SCH₃), 5.23 (s, 6H, O₆H₆), 6.42 (s, 1H, β-CH), 7.35-7.50 (m, 8H, Ar—H).

### Example 45

### Synthesis of Ruthenium Complex 11g (Scheme 12)

5a (0.21 g, 0.60 mmol), [(η⁶-C₆H₆)OsCl]₂Cl₂ (0.20 g, 0.29 mmol) and sodium triflate (0.13 g, 0.76 mmol) were added to a dry Schlenk. Dry degassed dichloromethane (10 mL) was transferred via cannula to give a brown solution which was stirred for 18 hours under N₂ at room temperature. The resulting dark red solution was filtered through Celite, washed with dry dichloromethane and the solvent removed in vaccuo. The residue was washed with dry pentane, which was decanted and the solid dried to give the product as a dark brown powder (0.26 g, 56%). Crystals suitable for x-ray were grown by slow diffusion (THF). The NMR for this complex shows two species, one containing the coordinated benzene ring (11g), and one where benzene has been lost (11h). Percentage yield based on complex 11g.

¹H NMR (400 MHz, CD₂Cl₂) δ ppm: 1.89, 2.28, 2.30, 2.36 (4 s (different stereoisomers), 6H, SCH₃), 2.53 (s, 6H, NCCH₃), 5.85 (s, 6H, C₆H₆), 6.04 (s, 1H, p-cm, 6.76-7.42 (m, 8H, Ar—H). ¹⁹F NMR (376 MHz, CD₂Cl₂) δ ppm: −78.8 (OTf).

### Examples for Dehydrogenation Reactions

### Examples 46-50, Comparative Example 8

### Dehydrogenation of DMAB in THF at 42° C. (FIG. 9)

Following the procedure of Exp. 26.

| | Catalyst | | | |
|---|---|---|---|---|
| Exp. | | | | |
| 46^{#} | 11a | 57 mg | 0.08 mmol | 0.5 mol % |
| 47^{#} | 11c | 59 mg | 0.08 mmol | 0.5 mol % |
| 48^{#} | 11d | 61 mg | 0.08 mmol | 0.5 mol % |
| 49^{#} | 11e | 104 mg | 0.08 mmol | 0.5 mol % |
| 50^{#} | 11f | 104 mg | 0.08 mmol | 0.5 mol % |
| Comp. Exp. | | | | |
| 8 | 7 | 54 mg | 0.08 mmol | 0.5 mol % |

^{#}DMAB added dissolved in THF

Various modifications and variations of the described aspects of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes of carrying out the invention which are obvious to those skilled in the relevant fields are intended to be within the scope of the following claims.

1. A process for the production of hydrogen comprising contacting at least one complex of formula (I), 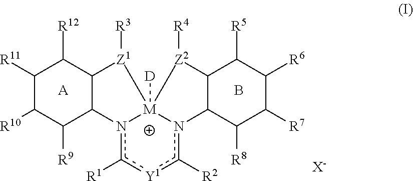
wherein:
X⁻ is an anion;
M is a metal selected from Ru, Os, Fe, Co and Ni;
D is optionally present and is one or more monodentate or multidentate donor ligands;
Y¹ is selected from CR¹³, B and N;
Z¹ and Z² are each independently selected from ═N, ═P, NR¹⁴, PR¹⁵, O, S and Se; or
Z² is a direct bond between carbocyclic ring B and substituent R⁴;
each of A and B is independently a saturated, unsaturated or partially unsaturated carbocyclic hydrocarbon ring;
R³ and R⁴ are each independently selected from H, C₁₋₆-alkyl, aryl and C₁₋₆-haloalkyl, and a linker group optionally attached to a solid support; or
R³ and R⁴ together form the following moiety: 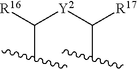
Y² is a direct single bond or double bond, or is CR¹⁸;
R¹, R², R⁵⁻¹³ and R¹⁶⁻¹⁸ are each independently selected from H, C₁₋₆-alkyl, C₂₋₆-alkenyl, C₂₋₆-alkynyl, aryl, C₁₋₆-haloalkyl, NR¹⁹R²⁰ and a linker group optionally attached to a solid support;
or two or more of said R¹⁻¹³ and R¹⁶⁻¹⁸ groups are linked, together with the carbons to which they are attached, to form a saturated or unsaturated hydrocarbon group;
R¹⁴, R¹⁵, R¹⁹ and R²⁰ are each independently selected from H, C₁₋₆-alkyl, C₂₋₆-alkenyl, C₂₋₆-alkynyl, aryl, C₁₋₆-haloalkyl, and a linker group optionally attached to a solid support;
with at least one substrate of formula (II)
R²¹R²²NH—BHR²³R²⁴ (II)
wherein R²¹ to R²⁴ are each independently selected from H, C₁₋₆-alkyl, fluoro-substituted C₁₋₆-alkyl, C₆₋₁₄ aryl and C₆₋₁₄ aralkyl, or any two of R²¹, R²², R²³ and R²⁴ are linked to form a C₃₋₁₀-alkylene group or C₃₋₁₀-alkenylene group, which together with the nitrogen and/or boron atoms to which they are attached, forms a cyclic group;
or a substrate comprising two, three or four substrates of formula (II) linked via one or more bridging groups so as to form a dimeric, trimeric or tetrameric species, and wherein the bridging group is selected from straight or branched C₁₋₆-alkylene optionally substituted by one or more fluoro groups; boron; C₆₋₁₄-aryl; and C₆₋₁₄-aralkyl;
or a substrate comprising two, three or four substrates of formula (II) which are joined so as to form a fused cyclic dimeric, trimeric or tetrameric species.

2. A process according to claim 1 wherein R²³ and R²⁴ are both H, one of R²¹ and R²² is H and the other is selected from H, CF₃, methyl, ethyl, isopropyl, n-propyl, isobutyl, n-butyl, tert-butyl, sec-butyl, phenyl and benzyl.

3. A process according to claim 1 wherein R²³ and R²⁴ are both H, and R²¹ and R²² are each independently selected from H, CF₃, methyl, ethyl, isopropyl, n-propyl, isobutyl, n-butyl, tert-butyl, sec-butyl, phenyl and benzyl, or R²¹ and R²² are linked to form a C₄-alkylene group, which together with the nitrogen atom to which they are attached, forms a cyclic group.

4. A process according to claim 1 wherein the substrate of formula (II) is selected from ammonia borane, methylamine borane, dimethylamine borane, di-isopropylamine borane, isopropylamine borane, tert-butylamine borane, isobutylamine borane, phenylamine borane and pyrrolidine borane, and mixtures thereof.

5. A process according to claim 1 wherein the substrate of formula (II) is ammonia borane (H₃B—NH₃).

6. A process according to claim 1 wherein X⁻ is selected from OTf⁻, BF₄⁻, PF₆⁻, BPh₄⁻ and BArF⁻ (B((3,5-CF₃)₂C₆H₃)₄⁻), more preferably, OTf⁻.

7. A process according to claim 1 wherein M is selected from Ru, Ni and Co.

8. A process according to claim 1 wherein R⁵ to R¹⁸ are each independently selected from H, methyl, CF₃ and isopropyl.

9. A process according to claim 1 wherein R³ and R⁴ are both independently C₁₋₆-alkyl, more preferably, Me.

10. A process according to claim 1 wherein Y₁ is CR¹³, more preferably CH.

11. A process according to claim 1 wherein A and B are both phenyl groups.

12. A process according to claim 1 wherein Z¹R³ and Z²R⁴ are each independently S—C₁₋₆-alkyl, more preferably Z¹R³ and Z²R⁴ are each independently selected from SCH₃ and SCH₂CH₃.

13. A process according to claim 1 wherein Z¹R³ and Z²R⁴ together form the following moiety:

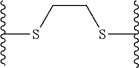 [SMILES: *SCCS*]

14. A process according to claim 1 wherein the compound of formula (I) is a compound of formula (V): 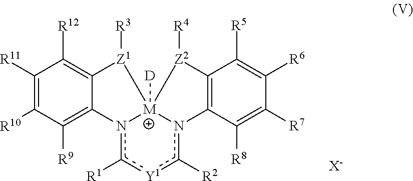
wherein R¹-R¹², D, M, Z¹, Z², Y¹ and X⁻ are as defined in claim 1.

15. A process according to claim 1 wherein the compound of formula (I) is a compound of formula (Va): 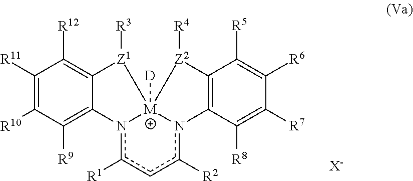
wherein:
X⁻ is an anion selected from Cl⁻, Br⁻, PF₆⁻, TfO⁻;
M is selected from Ru and Ni;
D is optional and is selected from (VI) and (VII), 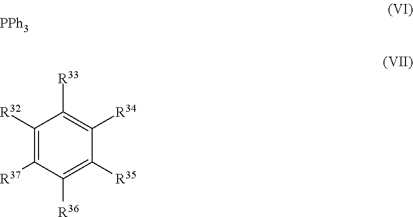
Z¹ and Z² are each independently selected from NR¹⁴, PR¹⁵, 0 and S; or Z² is a direct bond to R⁴;
R³ and R⁴ are each independently selected from H, C₁₋₆-alkyl, aryl and C₁₋₆-haloalkyl, and a linker group optionally attached to a solid support; or
R³ and R⁴ together form the following moiety: 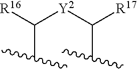
Y² is a direct single bond or double bond, or is CR¹⁸;
R¹, R², R⁵⁻¹³ and R¹⁶⁻¹⁸ are each independently selected from H, C₁₋₆-alkyl, C₂₋₆-alkenyl, C₂₋₆-alkynyl, aryl, C₁₋₆-haloalkyl, NR¹⁹R²⁰ and a linker group optionally attached to a solid support;
or two or more of said R¹⁻¹³ and R¹⁶⁻¹⁸ groups are linked, together with the carbons to which they are attached, to form a saturated or unsaturated hydrocarbon group; and
R¹⁴, R¹⁵, R¹⁹, R²⁰ and R³²⁻³⁶ are each independently selected from H, C₁₋₆-alkyl, C₂₋₆-alkenyl, C₂₋₆-alkynyl, aryl, C₁₋₆-haloalkyl, and a linker group optionally attached to a solid support.

16. A process according to claim 1 wherein the compound of formula (I) is a compound of formula (VIII): 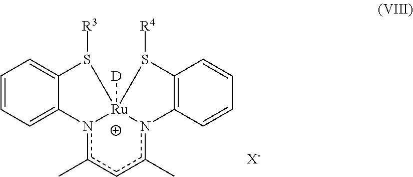
wherein R³, R⁴, D and X⁻ are as defined in claim 1.

17. A process according to claim 1 wherein:
X⁻ is an anion selected from Cl⁻ and TfO⁻;
D is optional and is selected from (VI) and (VII), 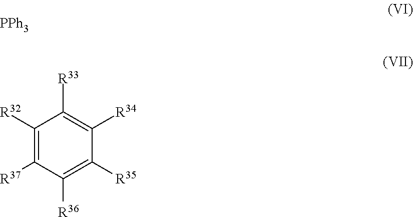
R³ and R⁴ are each independently selected from H, C₁₋₆-alkyl, aryl and C₁₋₆-haloalkyl, and a linker group optionally attached to a solid support.

18. A compound according to any-preceding claim 1 wherein:
(i) D is η⁶-C₆H₆, and X⁻ is Cl⁻;
(ii) D is η⁶-C₆H₆, and X⁻ is OTf;
(iii) D is absent, and X⁻ is Cl⁻;
(iv) D is absent, and X⁻ is OTf;
(v) D is PPh₃, and X⁻ is Cl⁻;
(vi) D is PPh₃, and X⁻ is OTf; or
(vii) D is absent, and X⁻ is Br⁻.

19. A process according to claim 1 wherein the compound of formula (I) is a compound selected from the following: 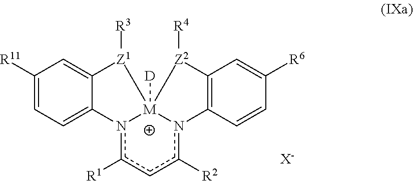
Compound 6a: M=Ru; D=η⁶-C₆H₆; Z¹⁻²=S; R¹⁻⁴=CH₃; R^{6,11}=H; X⁻=Cl⁻
Compound 6b: M=Ru; D=η⁶-C₆H₆; Z¹⁻²=S; R¹⁻²=CH₃; R³⁻⁴=CH₂CH₃; R^{6,11}=H; X⁻=Cl⁻
Compound 6c: M=Ru; D=none; Z¹⁻²=S; R¹⁻²=CH₃; R³⁻⁴=CH₂CH₃; R^{6,11}=H; X⁻=Cl⁻
Compound 6d: M=Ru; D=η⁶-C₆H₆; Z¹⁻²=O; R¹⁻⁴=CH₃; R^{6,11}=H; X⁻=Cl⁻
Compound 6e: M=Ru; D=η⁶-C₆H₆; Z¹⁻²=S; R¹⁻⁴=CH₃; R^{6,11}=H; X⁻=⁻OTf
Compound 6f: M=Ru; D=none; Z¹⁻²=S; R¹⁻⁴=CH₃; R^{6,11}=H; X⁻=⁻OTf
Compound 6g: M=Ru; D=η⁶-C₆H₆; Z¹⁻²=S; R¹⁻²=CH₃; R³⁻⁴=CH₂CH₃; R^{6,11}=H; X⁻=⁻OTf
Compound 6h: M=Ru; D=none; Z¹⁻²=S; R¹⁻²=CH₃; R³⁻⁴=CH₂CH₃; R^{6,11}=H; X⁻=⁻OTf
Compound 6i: M=Ru; D=η⁶-C₆H₆; Z¹⁻²=O; R¹⁻⁴=CH₃; R^{6,11}=H; X⁻=⁻OTf
Compound 6j: M=Ru; D=PPh₃; Z¹⁻²=S; R¹⁻⁴=CH₃; R^{6,11}=H; X⁻=Cl⁻
Compound 6k: M=Ru; D=PPh₃; Z¹⁻²=S; R¹⁻⁴=CH₃; R^{6,11}=H; X⁻=⁻OTf
Compound 6l: M=Ni; D=none; Z¹⁻²=S; R¹⁻⁴=CH₃; R^{6,11}=H; X⁻=Br⁻
Compound 6m: M=Ni; D=none; Z¹⁻²=S; R¹⁻⁴=CH₃; R^{6,11}=H; X⁻=PF₆⁻
Compound 6n: M=Ni; D=none; Z¹⁻²=S; R¹⁻²=CH₃; R³ and R⁴ together=CH₂CH₂; R^{6,11}=H; X⁻=PF₆⁻
Compound 6q: M=Ru; D=PPh₃; Z¹⁻²=S; R^{1-2,6,11} H; R³⁻⁴=CH₃; X⁻=⁻OTf
Compound 6r: M=Ru; D=PPh₃; Z¹⁻²=S; R^{1-2,6,11} H; R³⁻⁴=CH₃; X⁻=Cl⁻
Compound 11a: M=Ru; D=η⁶-C₆H₆; Z¹⁻²=S; R^{1-4,6,11}=CH₃; X⁻=⁻OTf
Compound 11b: M=Ru; D=none; Z¹⁻²=S; R^{1-4,6,11}=CH₃; X⁻=⁻OTf
Compound 11c: M=Ru; D=η⁶-(p-cymene); Z¹⁻²=S; R¹⁻⁴=CH₃; R^{6,11}=H; X⁻=⁻OTf
Compound 11d: M=Ru; D=η⁶-[C₆(CH₃)₆]; Z¹⁻²=S; R¹⁻⁴=CH₃; R^{6,11}=H; X⁻=⁻OTf
Compound 11e: M=Ru; D=η⁶-C₆H₆; Z¹⁻²=S; R¹⁻⁴=CH₃; R^{6,11}=H; X⁻=[(3,5-(CF₃)₂C₆H₃)₄B]⁻
Compound 11f: M=Ru; D=η⁶-C₆H₆; Z¹⁻²=S; R¹⁻⁴=CH₃; R^{6,11}=H; X⁻=SbF₆⁻
Compound 11g: M=Os; D=η⁶-C₆H₆; Z¹⁻²=S; R¹⁻⁴=CH₃; R^{6,11}=H; X⁻=⁻OTf
Compound 11h: M=Os; D=none; Z¹⁻²=S; R¹⁻⁴=CH₃; R^{6,11}=H; X⁻=⁻OTf

20. A process according to claim 1 wherein the compound of formula (I) is a compound of formula (VII) selected from the following: 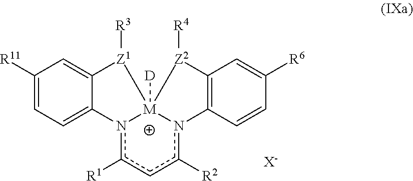
Compound 6e: M=Ru; D=η⁶-C₆H₆; Z¹⁻²=S; R¹⁻⁴=CH₃; R^{6,11}=H; X⁻=⁻OTf
Compound 6f: M=Ru; D=none; Z¹⁻²=S; R¹⁻⁴=CH₃; R^{6,11}=H; X⁻=⁻OTf
Compound 6g: M=Ru; D=η⁶-C₆H₆; Z¹⁻²=S; R¹⁻²=CH₃; R³⁴=CH₂CH₃; R^{6,11}=H; X⁻=⁻OTf
Compound 6h: M=Ru; D=none; Z¹⁻²=S; R¹⁻²=CH₃; R³⁻⁴=CH₂CH₃; R^{6,11}=H; X⁻=⁻OTf
Compound 6j: M=Ru; D=PPh₃; Z¹⁻²=S; R¹⁻⁴=CH₃; R^{6,11}=H; X⁻=Cl⁻
Compound 6k: M=Ru; D=PPh₃; Z¹⁻²=S; R¹⁻⁴=CH₃; R^{6,11}=H; X⁻=⁻OTf
Compound 11a: M=Ru; D=η⁶-C₆H₆; Z¹⁻²=S; R^{1-4,6,11}=CH₃; X⁻=⁻OTf
Compound 11b: M=Ru; D=none; Z¹⁻²=S; R^{1-4,6,11}=CH₃; X⁻=⁻OTf
Compound 11c: M=Ru; D=η⁶-(p-cymene); Z¹⁻²=S; R¹⁻⁴=CH₃; R^{6,11}=H; X⁻=⁻OTf
Compound 11d: M=Ru; D=η⁶-[C₆(CH₃)₆]; Z¹⁻²=S; R¹⁴=CH₃; R^{6,11}=H; X⁻=⁻OTf
Compound 11e: M=Ru; D=η⁶-C₆H₆; Z¹⁻²=S; R¹⁻⁴=CH₃; R^{6,11}=H; X⁻=[(3,5-(CF₃)₂C₆H₃)₄B]⁻
Compound 11f: M=Ru; D=η⁶-C₆H₆; Z¹⁻²=S; R¹⁻⁴=CH₃; R^{6,11}=H; X⁻=SbF₆⁻

21. A hydrogen generation system comprising:
(a) at least one complex of formula (I) 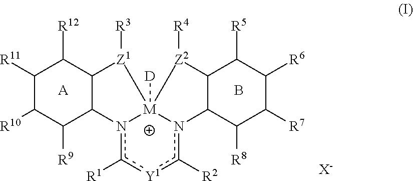
wherein:
X⁻ is an anion;
M is a metal selected from Ru, Os, Fe, Co and Ni;
D is optionally present and is one or more monodentate or multidentate donor ligands;
Y¹ is selected from CR¹³, B and N;
Z¹ and Z² are each independently selected from ═N, ═P, NR¹⁴, PR¹⁵, O, S and Se; or
Z² is a direct bond between carbocyclic ring B and substituent R⁴;
each of A and B is independently a saturated, unsaturated or partially unsaturated carbocyclic hydrocarbon ring;
R³ and R⁴ are each independently selected from H, C₁₋₆-alkyl, aryl and C₁₋₆-haloalkyl, and a linker group optionally attached to a solid support; or
R³ and R⁴ together form the following moiety: 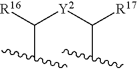
Y² is a direct single bond or double bond, or is CR¹⁸;
R¹, R², R⁵⁻¹³ and R¹⁶⁻¹⁸ are each independently selected from H, C₁₋₆-alkyl, C₂₋₆-alkenyl, C₂₋₆-alkynyl, aryl, C₁₋₆-haloalkyl, NR¹⁹R²⁰ and a linker group optionally attached to a solid support;
or two or more of said R¹⁻¹³ and R¹⁶⁻¹⁸ groups are linked, together with the carbons to which they are attached, to form a saturated or unsaturated hydrocarbon group;
R¹⁴, R¹⁵, R¹⁹ and R²⁰ are each independently selected from H, C₁₋₆-alkyl, C₂₋₆-alkenyl, C₂-6-alkynyl, aryl, C₁₋₆-haloalkyl, and a linker group optionally attached to a solid support;
(b) at least one substrate of formula (II)
R²¹R²²NH—BHR²³R²⁴ (II)
wherein R²¹ to R²⁴ are each independently selected from H, C₁₋₆-alkyl, fluoro-substituted C₁₋₆-alkyl, C₆₋₁₄ aryl and C₆₋₁₄ aralkyl, or any two of R²¹, R²², R²³ and R²⁴ are linked to form a C₃₋₁₀-alkylene group or C₃₋₁₀-alkenylene group, which together with the nitrogen and/or boron atoms to which they are attached, forms a cyclic group;
or a substrate comprising two, three or four substrates of formula (II) linked via one or more bridging groups so as to form a dimeric, trimeric or tetrameric species, and wherein the bridging group is selected from straight or branched C₁₋₆-alkylene optionally substituted by one or more fluoro groups, boron, C₆₋₁₄-aryl and C₆₋₁₄-aralkyl;
or a substrate comprising two, three or four substrates of formula (II) which are joined so as to form a fused cyclic dimeric, trimeric or tetrameric species; and
(c) optionally, a solvent.

22. A hydrogen generation system according to claim 21, comprising a first compartment comprising the at least one complex of formula (I), a second compartment comprising the at least one substrate of formula (II), and a means for combining the contents of the first compartment with the contents of the second compartment such that when the contents are combined, hydrogen is generated.

23. A hydrogen generation system according to claim 22, which further comprises at least one flow controller to control a flow rate of the at least one complex of formula (I) or the at least one substrate of formula (II).

24. A hydrogen generation system according to claim 21 wherein said system is connected to a proton exchange membrane fuel cell (PEMFC), or any other system requiring a supply of hydrogen.

25. (canceled)

26. A fuel cell comprising at least one complex of formula (I) as defined in claim 1.

27. A method of thermolytically dehydrogenating a substrate of formula (II) as defined in claim 1, said method comprising contacting at least one substrate of formula (II) as defined in claim 1 with a complex of formula (I) as defined in claim 1 in the presence of a solvent.

28-29. (canceled)

30. A method of using a hydrogen generation system according to claim 21 which comprises modulating the hydrogen pressure in said system so as to modulate activity of the at least one complex of formula (I).

31. (canceled)

32. A complex of formula (VII) selected from the following: 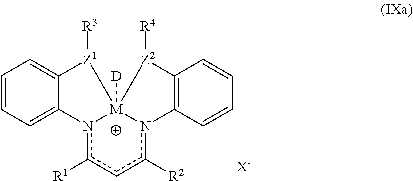
Compound 6a: M=Ru; D=η⁶-C₆H₆; Z¹⁻²=S; R¹⁻⁴=CH₃; X⁻=Cl⁻
Compound 6b: M=Ru; D=η⁶-C₆H₆; Z¹⁻²=S; R¹⁻²=CH₃; R³⁻⁴=CH₂CH₃; X⁻=Cl⁻
Compound 6c: M=Ru; D=none; Z¹⁻²=S; R¹⁻²=CH₃; R³⁻⁴=CH₂CH₃; X⁻=Cl⁻
Compound 6d: M=Ru; D=η⁶-C₆H₆; Z¹⁻²=O; R¹⁻⁴=CH₃; X⁻=Cl⁻
Compound 6e: M=Ru; D=η⁶-C₆H₆; Z¹⁻²=S; R¹⁻⁴=CH₃; X⁻=OTf⁻
Compound 6f: M=Ru; D=none; Z¹⁻²=S; R¹⁻⁴=CH₃; X⁻=OTf⁻
Compound 6g: M=Ru; D=η⁶-C₆H₆; Z¹⁻²=S; R¹⁻²=CH₃; R³⁻⁴=CH₂CH₃; X⁻=OTf⁻
Compound 6h: M=Ru; D=none; Z¹⁻²=S; R¹⁻²=CH₃; R³⁻⁴=CH₂CH₃; X⁻=OTf⁻
Compound 6i: M=Ru; D=η⁶-C₆H₆; Z¹⁻²=O; R¹⁻⁴=CH₃; X⁻=OTf⁻
Compound 6j: M=Ru; D=PPh₃; Z¹⁻²=S; R¹⁻⁴=CH₃; X⁻=Cl⁻
Compound 6k: M=Ru; D=PPh₃; Z¹⁻²=S; R¹⁻⁴=CH₃; X⁻=OTf⁻
Compound 6l: M=Ni; D=none; Z¹⁻²=S; R¹⁻⁴=CH₃; X⁻=Br⁻
Compound 6m: M=Ni; D=none; Z¹⁻²=S; R¹⁻⁴=CH₃; X⁻=PF₆⁻
Compound 6n: M=Ni; D=none; Z¹⁻²=S; R¹⁻²=CH₃; R³ and R⁴ together=CH₂CH₂; X⁻=PF₆⁻
Compound 6q: M=Ru; D=PPh₃; Z¹⁻²=S; R¹⁻²=H; R³⁻⁴=CH₃; X⁻=OTf⁻
Compound 6r: M=Ru; D=PPh₃; Z¹⁻²=S; R¹⁻²=H; R³⁻⁴=CH₃; X⁻=Cl⁻ 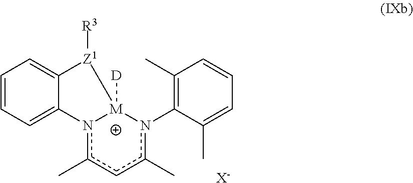
Compound 6o: M=Ru; D=η⁶-C₆H₆; Z¹=5; R³=CH₃; X⁻=Cl⁻
Compound 6p: M=Ru; D=η⁶-C₆H₆; Z¹=5; R³=CH₃; X⁻=OTf⁻
Compound 11a: M=Ru; D=η⁶-C₆H₆; Z¹⁻²=S; R^{1-4,6,11}=CH₃; X⁻=⁻OTf
Compound 11b: M=Ru; D=none; Z¹⁻²=S; R^{1-4,6,11}=CH₃; X⁻=⁻OTf
Compound 11c: M=Ru; D=η⁶-(p-cymene); Z¹⁻²=S; R¹⁻⁴=CH₃; R^{6,11}=H; X⁻=⁻OTf
Compound 11d: M=Ru; D=η⁶-[C₆(CH₃)₆]; Z¹⁻²=S; R¹⁻⁴=CH₃; R^{6,11}=H; X⁻=⁻OTf
Compound 11e: M=Ru; D=η⁶-C₆H₆; Z¹⁻²=S; R¹⁻⁴=CH₃; R^{6,11}=H; X⁻=[(3,5-(CF₃)₂C₆H₃)₄B]⁻
Compound 11f: M=Ru; D=η⁶-C₆H₆; Z¹⁻²=S; R¹⁻⁴=CH₃; R^{6,11}=H; X⁻=SbF₆
Compound 11g: M=Os; D=η⁶-C₆H₆; Z¹⁻²=S; R¹⁻⁴=CH₃; R^{6,11}=H; X⁻=⁻OTf
Compound 11h: M=Os; D=none; Z¹⁻²=S; R¹⁻⁴=CH₃; R^{6,11}=H; X⁻=⁻OTf
